(19) United States
(12) Patent Application Publication
(10) Pub. No.: US 2026/0154134 A1
(43) Pub. Date: Jun. 4, 2026

(54) Transferring Data From A Sender Realm To A Receiver Realm

(71) Applicant: Oracle International Corporation, Redwood Shores, CA (US)

(72) Inventors: Vlad Coman, Seattle, WA (US); Martinus Petrus van den Dungen, Snohomish, WA (US); Parth Patni, Lynnwood, WA (US); Venu Bangalore Parameshwara Setty, Seattle, WA (US); Venkateswarlu Edala, Hyderabad (IN)

(73) Assignee: Oracle International Corporation, Redwood Shores, CA (US)

(21) Appl. No.: 19/407,856

(22) Filed: Dec. 3, 2025

Related U.S. Application Data
(60) Provisional application No. 63/727,416, filed on Dec. 3, 2024.

(51) Int. Cl. G06F 9/54; G06F 9/38

(52) U.S. Cl. CPC G06F 9/542; G06F 9/3885

(57) ABSTRACT

Techniques for configuring a communication channel between a first realm and a second realm are disclosed. A cross-realm service deployed in a first realm receives a user input that includes a request to activate a first pipeline deployed in the first realm for the communication channel. The user input includes a pipeline identifier of a second pipeline deployed in the second realm. The cross-realm service activates the first pipeline, including adding a mapping between the first pipeline and the second pipeline to a set of pipeline mappings stored in the first realm. The mapping is added based on the pipeline identifier of the second pipeline. Data is transmitted over the communication channel based on the mapping between the first pipeline and the second pipeline stored in the first realm without relying on any mapping between the first pipeline and the second pipeline stored in the second realm.

### BENEFIT CLAIMS; RELATED APPLICATIONS; INCORPORATION BY REFERENCE

This application claims the benefit of U.S. Provisional Patent Application 63/727,416, filed Dec. 3, 2024, that is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to transferring data from a sender realm to a receiver realm. More particularly, the present disclosure relates to configuring and utilizing communication channels for transferring data from a sender realm to a receiver realm.

### BACKGROUND

A sender realm can transfer data to a receiver realm to facilitate data sharing, service delegation, or resource access across different security or administrative boundaries. The sender realm and the receiver realm may represent distinct trust zones or administrative units, such as different organizations, departments, or subsystems. The sender realm and the receiver realm may have distinct security policies and/or access permissions.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment, and they mean at least one. In the drawings:

FIG. 1 illustrates a system for transferring data from a sender realm to a receiver realm in accordance with one or more embodiments;

FIG. 2A illustrates an example set of operations for configuring a sender realm to transfer data to a receiver realm in accordance with one or more embodiments;

FIGS. 2B and 2C illustrate an example set of operations for configuring a receiver realm to receive data from a sender realm in accordance with one or more embodiments;

FIG. 3A illustrates an example set of operations for transferring data from a sender realm to a receiver realm in accordance with one or more embodiments;

FIGS. 3B and 3C illustrate an example set of operations for receiving data at a receiver realm from a sender realm in accordance with one or more embodiments;

FIG. 4A illustrates an example set of operations for configuring a receiver realm to receive data from a sender realm in accordance with one or more embodiments;

FIG. 4B illustrates an example set of operations for configuring a sender realm to transfer data to a receiver realm in accordance with one or more embodiments;

FIG. 5A illustrates an example set of operations for transferring data from a sender realm to a receiver realm in accordance with one or more embodiments;

FIGS. 5B and 5C illustrate an example set of operations for receiving data at a receiver realm from a sender realm in accordance with one or more embodiments;

FIGS. 6A and 6B illustrate an example implementation of a system for transferring data from a sender realm to a receiver realm in accordance with one or more embodiments;

FIGS. 6C and 6D illustrate another example implementation of a system for transferring data from a sender realm to a receiver realm in accordance with one or more embodiments;

FIGS. 7-10 are block diagrams illustrating patterns for implementing a cloud infrastructure as a service system in accordance with one or more embodiments; and

FIG. 11 is a hardware system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The term “cloud computing service” or “cloud service” is generally used to refer to a service made available by a cloud services provider (CSP) to users or customers on demand (e.g., via a subscription model) using systems and infrastructure (cloud infrastructure) provided by the CSP.

In most cases, the CSP is a third-party service that specializes in providing (e.g., offering, renting, selling) cloud services to customers. The servers and systems that make up the CSP's infrastructure are separate from the customer's own on-premise servers and systems. Customers can thus avail themselves of cloud services provided by the CSP without having to purchase separate hardware and software resources for the services. Cloud services are designed to provide a subscribing customer with easy, scalable access to applications and computing resources without the customer having to invest in procuring the infrastructure used for providing the services. In some instances, an entity might opt to deploy a private cloud, becoming its own provider of cloud services. In some instances, an entity may utilize both a private cloud and a public cloud provided by a third-party CSP, thereby forming a hybrid cloud.

There are several cloud service providers that offer various types of cloud services. There are various different types or models of cloud services, including Software-as-a-Service (SaaS), Platform-as-a-Service (PaaS), Infrastructure-as-a-Service (IaaS), and others. In an IaaS model, the CSP provides infrastructure (referred to as “cloud services provider infrastructure” or “CSPI”) that can be used by customers to build their own customizable networks and deploy customer resources.

A customer can subscribe to one or more cloud services provided by a CSP. The customer can be any entity. When a customer subscribes to or registers for a service provided by a CSP, a tenancy, or an account, is created for that customer. The customer can then, via this account, access the subscribed-to one or more cloud resources associated with the account.

### Table of Contents

1. GENERAL OVERVIEW
2. EXAMPLE SYSTEM ARCHITECTURE FOR TRANSFERRING DATA FROM A SENDER REALM TO A RECEIVER REALM
3. EXAMPLE OPERATIONS FOR TRANSFERRING DATA FROM A SENDER REALM TO A RECEIVER REALM
4. EXAMPLE EMBODIMENTS
5. PRACTICAL APPLICATIONS, ADVANTAGES, AND IMPROVEMENTS
6. CLOUD COMPUTING TECHNOLOGY
7. COMPUTER SYSTEM
8. MISCELLANEOUS; EXTENSIONS

### 1. General Overview

One or more embodiments transmit data over a cross-realm communication channel based on a mapping stored in a first realm between a first pipeline deployed in the first realm and a second pipeline deployed in a second realm without identifying the first pipeline outside the first realm. Data is transmitted over the communication channel based on the mapping stored in the first realm without relying on any mapping between the first pipeline and the second pipeline stored in the second realm. The first realm may be a sender realm that sends data to the second realm over the cross-realm communication channel. Alternatively, the second realm may be a sender realm that sends data to the first realm over the cross-realm communication channel.

In one example, a cross-realm service deployed in the first realm receives a user input that includes a request to activate the first pipeline deployed in the first realm for the communication channel. The user input includes a pipeline identifier of a second pipeline deployed in the second realm. Based on the pipeline identifier of the second pipeline, the cross-realm service adds a mapping between the first pipeline and the second pipeline to a set of pipeline mappings stored in the first realm. The cross-real service determines that data has been received from the second realm over the cross-realm communication channel. The data is accompanied by a manifest that includes a pipeline identifier that identifies the second pipeline. The cross-realm service determines that the data is intended for the first pipeline by accessing the mapping between the first pipeline and the second pipeline based on the pipeline identifier from the manifest. In one example, no data is transmitted from the first realm to the second realm. By refraining from transmitting data from the first realm to the second realm, the system avoids the potential for exfiltration of sensitive information from the first realm.

One or more embodiments utilize a pipeline-specific key pair that is unique to a particular sender pipeline for securely transmitting data over a cross-realm communication channel between the sender pipeline and a receiver pipeline. A cross-realm service in a sender realm generates a pipeline-specific key pair associated with a sender pipeline and transmits a public key of the pipeline-specific key pair to a receiver realm when initializing the cross-realm communication channel. The cross-realm service utilizes a private key of the pipeline-specific key pair to secure data for transmission across the cross-realm communication channel and transmits the data to the receiver realm over the cross-realm communication channel. A cross-realm service in the receiver realm utilizes the public key of the pipeline-specific key pair to access the data received over the cross-realm communication channel. By utilizing unique pipeline-specific key pairs for different cross-realm communication channels, the security provided by the pipeline-specific key pair for a particular cross-realm communication channels is independent of other cross-realm communication channels. For example, if a pipeline-specific key pair for a particular cross-realm communication channel becomes compromised, other cross-realm communication channels may be unaffected.

One or more embodiments include multiple sets of peered sender pipelines and receiver pipelines. The different sets of peered sender pipelines and receiver pipelines may correspond to different tenants of the sender realm and/or different tenants of the receiver realm. Additionally, or alternatively, the different sets of peered sender pipelines and receiver pipelines may represent different restriction levels. The different restriction levels may be represented by different security policies and/or access permissions. A particular restriction level can be applied to data transferred from a sender realm to a receiver realm by utilizing a cross-realm communication channel corresponding to the particular restriction level, security policy, and/or access permission.

One or more embodiments described in this Specification and/or recited in the claims may not be included in this General Overview section.

### 2. Example System Architecture for Transferring Data from a Sender Realm to a Receiver Realm

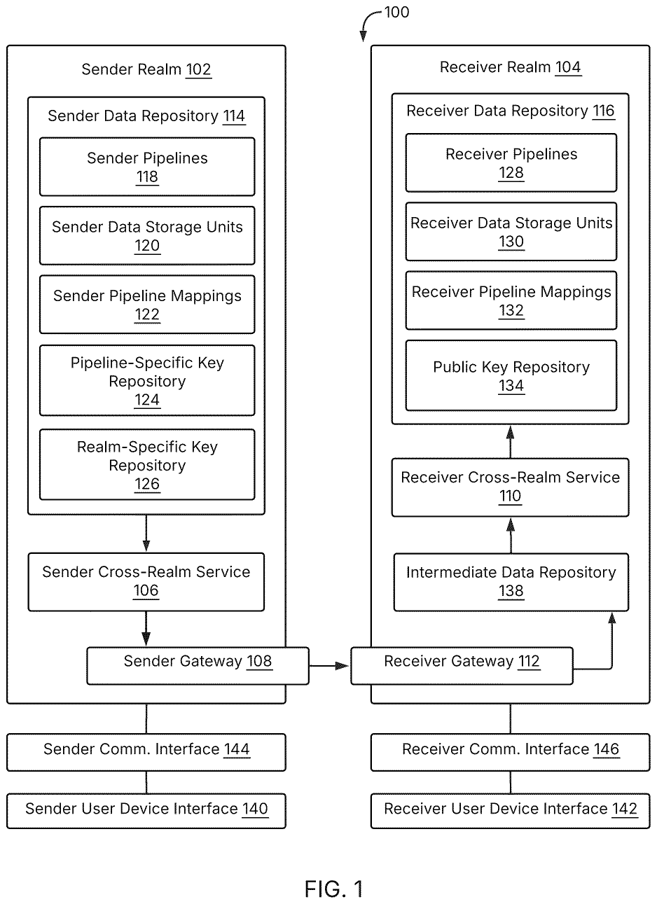

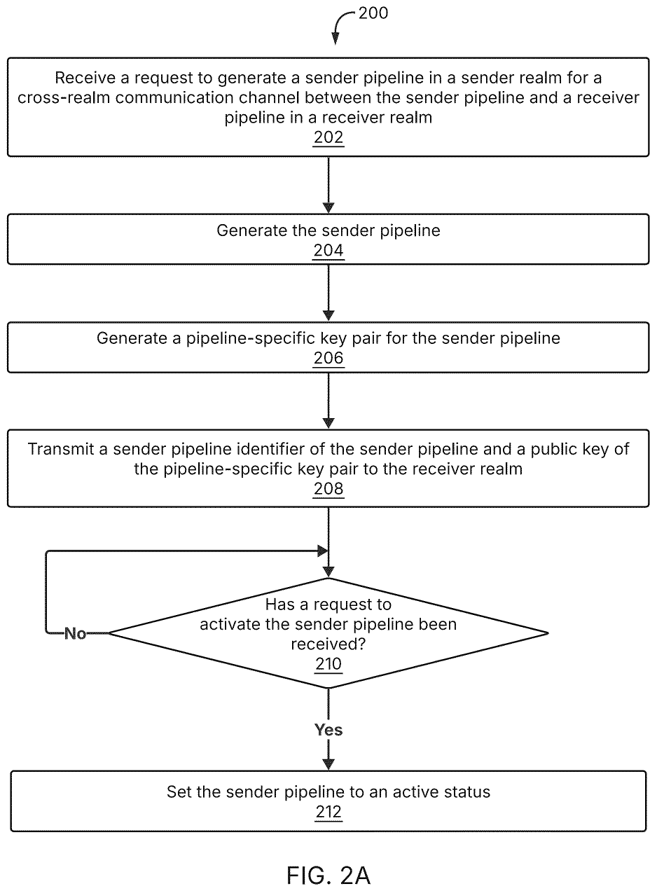

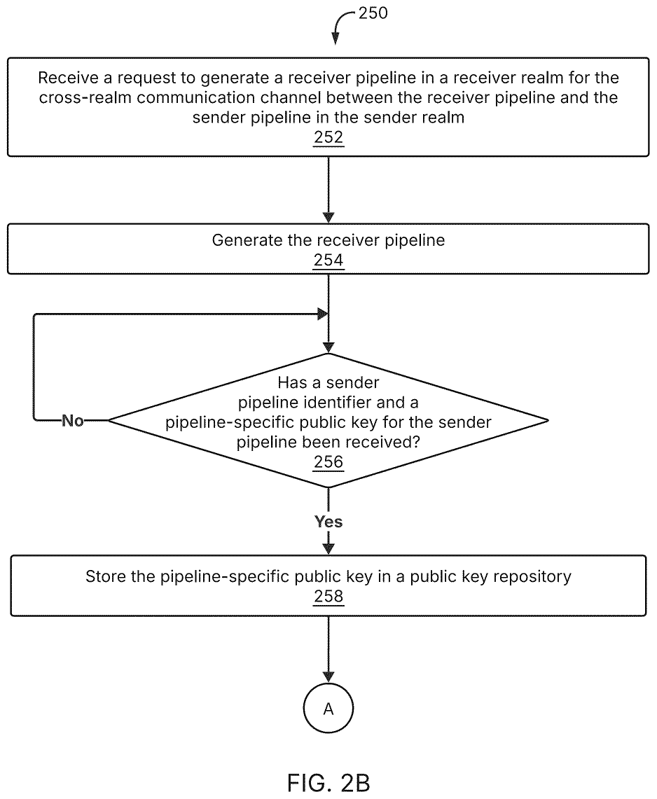

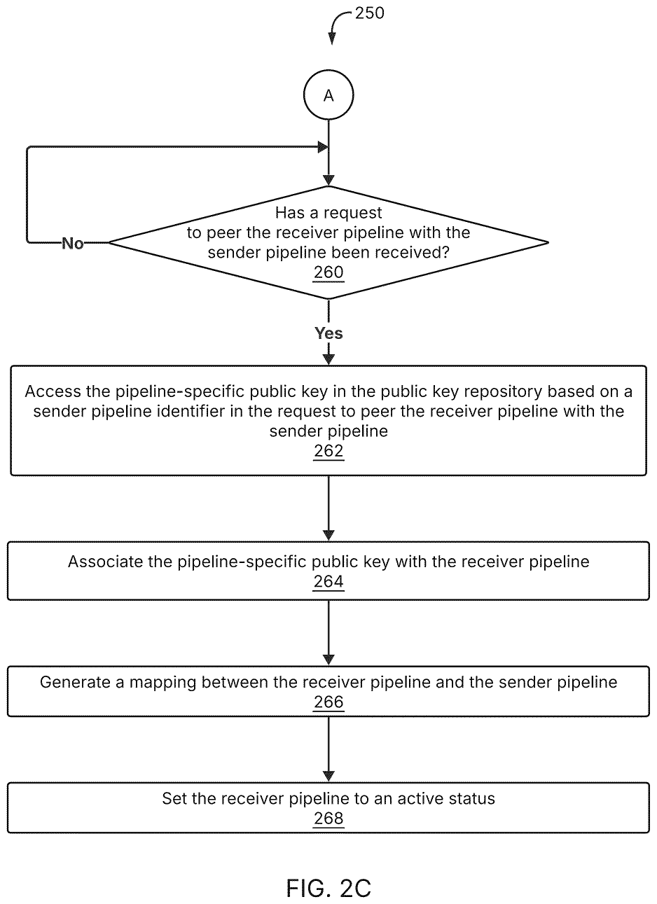

FIG. 1 illustrates features of an example system 100 for transferring data from a sender realm to a receiver realm in accordance with one or more embodiments. In one or more embodiments, the system 100 refers to hardware and/or software configured to perform operations described herein. Examples of operations are described below with reference to FIGS. 2A-2C, FIGS. 3A-3C, FIGS. 4A and 4B, and FIGS. 5A-5C. In one example, the system described with reference to FIG. 1 may include one or more features described below in Section 6, titled “Cloud Computing Technology,” and/or in Section 7, titled “Computer System.”

In one or more embodiments, the system 100 may include more or fewer components than the components described with reference to FIG. 1. The components described with reference to FIG. 1 may be local to or remote from each other. The components described with reference to FIG. 1 may be implemented in software and/or hardware. The components of system 100 may be distributed over multiple applications and/or machines. Multiple components may be combined into one application and/or machine. Operations described with respect to one component may instead be performed by another component.

As shown in FIG. 1, a system 100 includes a sender realm 102 and a receiver realm 104. The sender realm 102 and the receive realm 104 may operate in accordance with different restriction levels, such as different security policies and/or access permissions, relative to one another. The system 100 executes cross-realm communications between the sender realm 102 and the receiver realm 104 in compliance with restrictions on cross-realm communications applicable to the sender realm 102 and the receiver realm 104, respectively. The restrictions on cross-realm communications may include security policies and/or access permissions that restrict one or more aspects of cross-realm communication. The restrictions on cross-realm communication may be in place to provide heightened protection to a realm, information within the realm, and/or operations executed within the realm.

The restrictions on cross-realm communications may include restrictions on data egress from a realm. In one example, a realm may be subject to a restriction that prohibits data egress from the realm over a cross-realm communication channel. The restriction on data egress may be applicable to data egress generally and/or to a certain type of data. The restriction may apply to a particular type of data such as data of a sensitive nature. The restriction may be inapplicable to a particular type of data such as data that is less sensitive.

Examples of data that may be subject to a restriction on cross-realm communication, such as a restriction on data egress, may include data pertaining to one or more of the following types of information: proprietary information, confidential information, classified information, privileged information, security information, financial information, health information, personal identity information, biometric information, cryptographic information, or authentication information. Examples of data that may not be subject to a particular restriction on cross-realm communication for a particular realm may include data pertaining to one or more of the following types of information: publicly available information, anonymized information, or information intended for public dissemination.

The restrictions on cross-realm communications may be applicable to a particular subset of a realm such as a particular tenancy of the realm. The particular subset of the realm may store or utilize data of a sensitive nature. The restriction may be inapplicable to a particular subset of the realm such as a particular tenancy of the realm. The restrictions on cross-realm communication may be defined by a customer, tenant, or cloud service provider. Restrictions on cross-realm communication may change from time to time, for example, based on particular circumstances such as the type of data stored in a realm, the type of operations executed in the realm, and/or applicable rules, regulations, or policies.

In one example, the restriction on data egress prohibits transmission of entity identifiers such as identifiers for pipelines utilized for a cross-realm communication channel. A high realm may be restricted from sharing a pipeline identifier with a low realm for the cross-realm communication channel. A low realm may be permitted to share a pipeline identifier with a high realm.

In one example, the restriction on data egress prohibits transmission of cryptographic key information such as a pipeline-specific keys utilized for securing data transmitted over a cross-realm communication channel. A high realm may be restricted from sharing a pipeline-specific key with a low realm for the cross-realm communication channel. A low realm may be permitted to share a pipeline-specific key with a high realm.

The term “realm” refers to a logical construct that defines a cloud computing environment that is logically isolated from other cloud computing environments and that operates on physical components of a cloud infrastructure that are physically isolated from other physical components of the cloud infrastructure. By default, there is no direct network communication or resource sharing between different realms. The logical and physical isolation of a realm ensures that data and operations of the realm are segregated, for example, for security, compliance, governance, or business purposes. Additionally, the logical and physical isolation of a realm prevents data leakage from the realm as well as unauthorized access to the realm. Some cloud environments allow for trust relationships or federated access between different realms. This can allow resources or services in one realm to access or communicate with those in another realm under specific, controlled circumstances. Cross-realm communication generally requires explicit configuration and heightened security controls. A cross-realm communication channel can be utilized to allow cross-realm communication between a sender realm and a receiver realm.

As used herein, the term “sender realm” refers to a realm that transmits data, or is being configured to transmit data, to another realm over a cross-realm communication channel. As used herein, the term “receiver realm” refers to a realm that receives data, or is being configured to receive data, from another realm over a cross-realm communication channel. The terms sender realm and receiver realm are used in relation to a cross-realm communication channel between realms. A realm may be a sender realm in relation to a first cross-realm communication channel and a receiver realm in relation to a second cross-realm communication channel.

As used herein, the term “low realm” refers to a realm associated with a cross-realm communication channel that has a lower level of restriction on cross-realm communications relative to another realm associated with the cross-realm communication channel. As used herein, the term “high realm” refers to a realm associated with a cross-realm communication channel that has a higher level of restriction on cross-realm communications relative to another realm associated with the cross-realm communication channel. A high realm may be subject to a restriction on data egress from the realm. A high realm may be restricted from utilizing the cross-realm communication channel to transmit data to the low realm. A low realm may free from the restriction on data egress that applies to the high realm. A low realm may utilize the cross-realm communication channel to transmit data to the high realm.

A used herein, the term “pipeline” refers to a logical entity that represents an endpoint of a cross-real communication channel. As used herein, the term “sender pipeline” refers to pipeline deployed in a sender realm 102 that represents an upstream endpoint of a cross-realm communication channel. As used herein, the term “receiver pipeline” refers to a pipeline deployed in a receiver realm 104 that represents a downstream endpoint of a cross-realm communication channel.

Referring to FIG. 1, in one example, the sender realm 102 is a low realm, and the receive realm 104 is a high realm. Additionally, or alternatively, the sender realm 102 can be a high realm and the receive realm 104 can be a low realm.

The sender realm 102 may include a set of partitions that represent logically or physically isolated portions of the sender realm 102. The set of partitions may include at least one sender tenancy. Additionally, or alternatively, the set of partitions may include at least one service tenancy. The sender realm 102 includes a sender cross-realm service 106 that supports one or more cross-realm communication channels between the sender realm 102 and the receiver realm 104. The sender cross-realm service 106 executes operations within the sender realm 102 associated with one or more cross-realm communication channels. The sender cross-realm service 106 may be located in the service tenancy of the sender realm 102. The sender realm 102 includes a sender gateway 108 for sending data to the receiver realm 104, for example, over one or more cross-realm communication channels. The sender gateway 108 may be located in a service tenancy such as a cross-realm service tenancy. The sender gateway 108 includes at least one communications interface for transmitting data from the sender realm 102 to the receiver realm 104. The at least one communications interface may include hardware and/or software configured to transmit and/or to receive data.

The receiver realm 104 may include a set of partitions that represent logically or physically isolated portions of the receiver realm 104. The set of partitions may include at least one receiver tenancy. Additionally, or alternatively, the set of partitions may include at least one service tenancy. The receiver realm 102 includes a receiver cross-realm service 110 that supports one or more cross-realm communication channels between the receiver realm 104 and the sender realm 102. The receiver cross-realm service 110 executes operations within the receiver realm 104 associated with one or more cross-realm communication channels. The receiver cross-realm service 110 may be located in the service tenancy of the receiver realm 104. The receiver realm 104 includes a receiver gateway 112 for receiving data from the sender realm 102, for example, over one or more cross-realm communication channels. The receiver gateway 112 may be located in a service tenancy such as a cross-realm service tenancy. The receiver gateway 112 includes at least one communications interface for receiving data transmitted to the receiver realm 104 from the sender realm 102. The at least one communications interface may include hardware and/or software configured to transmit and/or to receive data.

The sender realm 102 and the receiver realm 104 may represent different security or administrative boundaries. The sender realm 102 and the receiver realm 104 may represent distinct trust zones or administrative units, such as different organizations, departments, or subsystems. The sender realm 102 and the receiver realm 104 may have distinct security policies and/or access permissions. In one example, the sender realm 102 and the receiver realm 104 represent different portions of a distributed system and/or different portions of a multi-realm environment.

The sender realm 102 includes a sender data repository 114. The receiver realm 104 includes a receiver data repository 116. The sender data repository 114 includes data utilized by the sender realm 102 to execute operations described herein. Additionally, or alternatively, the sender data repository 114 may include data generated or obtained by the sender realm 102 when executing operations described herein. Additionally, or alternatively, the sender data repository 114 includes data to be transmitted to the receiver realm 104 over one or more cross-realm communication channels. The receiver data repository 116 includes data utilized by the receiver realm 104 to execute operations described herein. Additionally, or alternatively, the receiver data repository 116 may include data generated or obtained by the receiver realm 104 when executing operations described herein. Additionally, or alternatively, the receiver data repository 116 includes data received from the sender realm 102 over one or more cross-realm communication channels.

In one or more embodiments, a data repository, such as the sender data repository 114 and/or the receiver data repository 116, includes any type of storage unit and/or device (e.g., a file system, database, collection of tables, or any other storage mechanism) for storing data. Furthermore, a data repository may include multiple different storage units and/or devices. The multiple different storage units and/or devices may or may not be of the same type or located at the same physical site. The sender data repository 114 may be implemented or executed on the same computing system as the sender cross-realm service 106 or on a separate computing system from the sender cross-real service 106. The sender data repository 114 may be communicatively coupled to the sender cross-realm service 106 via a direct connection or via a network. The receiver data repository 116 may be implemented or executed on the same computing system as the receiver cross-realm service 110 or on a separate computing system from the receiver cross-realm service 110. The receiver data repository 116 may be communicatively coupled to the receiver cross-realm service 110 via a direct connection or via a network.

As shown in FIG. 1, the sender data repository 114 may include one or more of the following: sender pipelines 118, sender data storage units 120, sender pipeline mappings 122, a pipeline-specific key repository 124, or a realm-specific key repository 126. The sender data repository 114 may include one or more sender pipelines 118 and one or more sender data storage units 120. A sender pipeline 118 represents an upstream endpoint of a cross-realm communication channel between the sender realm 102 and the receive realm 104. A sender data storage unit 120 includes data associated with a particular sender pipeline 118 of a cross-realm communication channel. A sender data storage unit 120 represents a repository for storing data to be transferred over a cross-realm communication channel corresponding to a particular sender pipeline 118. The data in a sender data storage unit 120 includes data to be transferred to the receiver realm 104 over the cross-realm communication channel. A sender data storage unit 120 and a sender pipeline 118 can be mapped to one another in a 1:1 relationship. The sender data storage unit 120 and the sender pipeline 118 may be located in a sender tenancy. Different sets of a sender data storage unit 120 and a sender pipeline 118 that are mapped to one another may be located in different sender tenancies.

The receiver data repository 116 may include one or more of the following: receiver pipelines 128, receiver data storage units 130, receiver pipeline mappings 132, or a public key repository 134. The receiver data repository 116 may include one or more receiver pipelines 128 and one or more receiver data storage units 130. A receiver pipeline 128 represents a downstream endpoint of a cross-realm communication channel between the sender realm 102 and the receive realm 104. A receiver data storage unit 130 represents a destination repository for storing data transferred over a cross-realm communication channel corresponding to a particular receiver pipeline 128. A receiver data storage unit 130 includes data associated with a particular receiver pipeline 128 of a cross-realm communication channel. The data in a receiver data storage unit 130 includes data received from the sender realm 102 over the cross-realm communication channel. A receiver data storage unit 130 and a receiver pipeline 128 can be mapped to one another in a 1:1 relationship. The receiver data storage unit 130 and the receiver pipeline 128 may be located in a sender tenancy. Different sets of a receiver data storage unit 130 and a receiver pipeline 128 that are mapped to one another may be located in different sender tenancies.

The sender pipeline mappings 122 includes mappings between sender pipelines 118 and receiver pipelines 128 that are stored in the sender data repository 114. In one example, the sender data repository 114 includes sender pipeline mappings 122 between a particular sender pipeline 118 and a particular receiver pipeline 128 for cross-realm communication channels where the sender realm 102 is a high realm. The mappings may include a sender pipeline identifier for the sender pipeline 118 and a receiver pipeline identifier for the receiver pipeline 128. In one example, the sender data repository 114 does not include sender pipeline mappings 122 for cross-realm communication channels where the sender realm 102 is a low realm. In one example, for a cross-realm communication channel where the sender realm 102 is a low realm, information pertaining to the receiver pipeline 128 of the cross-realm communication channel, such as a receiver pipeline identifier, is not communicated to the sender realm 102 and/or is not stored in the sender data repository 114.

When a cross-realm communication channel includes a sender pipeline mapping 122 in the sender realm 102, the sender cross-realm service 106 may determine a receiver pipeline 128 for the cross-realm communication channel based on the sender pipeline mapping 122. The sender cross-realm service 106 may generate a manifest that includes a receiver pipeline identifier of the receiver pipeline 128 from the sender pipeline mapping 122. The sender cross-realm service 106 includes the manifest in a message to identify the receiver pipeline 128 as the downstream endpoint for the message transmitted over the cross-realm communication channel.

When a cross-realm communication channel does not include a sender pipeline mapping 122 in the sender realm 102, the sender cross-realm service 106 may identify messages based on the sender pipeline 118 without determining the receiver pipeline 128. The sender cross-realm service 106 may generate a manifest that includes a sender pipeline identifier of the sender pipeline 118. The sender cross-realm service 106 includes the manifest in a message to identify the sender pipeline 118 as the upstream endpoint for the message transmitted over the cross-realm communication channel.

The receiver pipeline mappings 132 includes mappings between receiver pipelines 128 and sender pipelines 118 that are stored in the receiver data repository 116. In one example, the receiver data repository 116 includes receiver pipeline mappings 132 between a particular receiver pipeline 128 and a particular sender pipeline 118 for cross-realm communication channels where the receiver realm 104 is a high realm. The mappings may include a receiver pipeline identifier for the receiver pipeline 128 and a sender pipeline identifier for the sender pipeline 118. In one example, the receiver data repository 116 does not include receiver pipeline mappings 132 for cross-realm communication channels where the receiver realm 104 is a low realm. In one example, for a cross-realm communication channel where the receiver realm 104 is a low realm, information pertaining to the sender pipeline 118 of the cross-realm communication channel, such as a sender pipeline identifier, is not communicated to the receiver realm 104 and/or is not stored in the receiver data repository 116.

When a cross-realm communication channel includes a receiver pipeline mapping 132 in the receiver realm 104, the receiver cross-realm service 110 may determine a receiver pipeline 128 for the cross-realm communication channel based on the receiver pipeline mapping 132. The receiver cross-realm service 110 may determine a sender pipeline 118 based on a sender pipeline identifier in a manifest accompanying a message received from the sender realm 102. The receiver cross-realm service 110 determines the receiver pipeline 128 corresponding to the sender pipeline 118 based on the receiver pipeline mapping 132. When a cross-realm communication channel does not include a receiver pipeline mapping 132, a message may be identified based on the receiver pipeline 128 without specifying a sender pipeline 118. The receiver cross-realm service 110 determines the receiver pipeline 128 based on a receiver pipeline identifier in a manifest accompanying the message.

The receiver realm 104 includes an intermediate data repository 138. The receiver gateway 112 stores messages received from the sender realm 102 in the intermediate data repository 138. The receiver cross-realm service 110 accesses messages stored in the intermediate data repository 138 and determines the receiver pipeline 128 corresponding to the particular message. The receiver cross-realm service 110 determines a receiver data storage unit 130 corresponding to the receiver pipeline 128 and transfers the contents of the message, such as a file, to the receiver data storage unit 130.

To facilitate the transfer of objects from the sender realm 102 to the receiver realm 104, a sender pipeline 118 and a receiver pipeline 128 are peered with one another to specify upstream and downstream endpoints, respectively, of a cross-realm communication channel. After the sender pipeline 118 and the receiver pipeline 128 are peered with one another, to transfer an object from the sender realm 102 to the receiver realm 104 over the cross-realm communication channel, the data is stored in the sender data storage unit 120. The sender cross-realm service 106 determines that the data is stored in the sender data storage unit 120 and generates a message for transmitting the data the cross-realm communication channel. The sender cross-realm service 106 transfers the message to the sender gateway 108. The sender gateway 108 transmits the message to the receiver gateway 112 of the receiver realm 104. The receiver gateway 112 stores the message in the intermediate data repository 138. The receiver cross-realm service 110 determines that the message is stored in the intermediate data repository 138, determines the receiver pipeline 128 associated with the message, and transfers the contents of the message, such as a file, to the receiver data storage unit 130 corresponding to the receiver pipeline 128. Once the object is stored in the receiver data storage unit 130, the contents of the message, such as the file, may be utilized within the receiver realm 104.

The sender data repository 114 includes a pipeline-specific key repository 124 and/or a realm-specific key repository 126. The pipeline-specific key repository 124 includes pipeline-specific key pairs. The realm-specific key repository 126 includes realm-specific key pairs. The sender cross-realm service 106 may utilize a pipeline-specific key pair for securing messages when the sender realm 102 is a low realm. The sender cross-realm service 106 may utilize a realm-specific key pair for securing messages when the sender realm 102 is a high realm.

Pipeline-specific key pairs are key pairs that are associated with a particular sender pipeline 118 and are utilized exclusively for data security of messages transmitted over a cross-realm communication channel corresponding to the particular sender pipeline 118.

The sender cross-realm service 106 may generate a pipeline-specific key pair when initializing a cross-realm communication channel. The sender cross-realm service 106 may store the pipeline-specific key pair in the pipeline-specific key repository 124 in association with a particular sender pipeline 118 corresponding to the pipeline-specific key pair. The pipeline-specific key repository 124 may include multiple pipeline-specific key pairs corresponding to different sender pipelines 118, respectively. A pipeline-specific key pair includes a pipeline-specific private key that can be utilized to secure data and a pipeline-specific public key that can be utilized to access data. The sender cross-realm service 106 can generate a digital signature utilizing a pipeline-specific private key of a pipeline-specific key pair. In one example, the cross-realm service 106 has exclusive access to utilize the pipeline-specific private key. The receiver cross-realm service 110 can validate the digital signature utilizing a pipeline-specific public key of the pipeline-specific key pair. Additionally, or alternatively, the sender cross-realm service 106 can encrypt data utilizing a pipeline-specific private key of a pipeline-specific key pair. The receiver cross-realm service 110 can decrypt the encrypted data utilizing a pipeline-specific public key of the pipeline-specific key pair.

Realm-specific key pairs are key pairs that are associated with a particular sender realm 102 and are utilized for data security of messages transmitted over a cross-realm communication channel corresponding to the particular sender ream 102. A realm-specific key pair may be stored in the realm-specific key repository 126 during a provisioning process for the sender realm 102. Additionally, or alternatively, the realm-specific key pair may be stored in the realm-specific key repository 126 during a provisioning process for the sender cross-realm service 106 and/or when initializing a cross-realm communication channel. A realm-specific key pair can be utilized for multiple cross-realm communication channels associated with the sender realm 102. The realm-specific key repository 126 may include multiple realm-specific key pairs corresponding to different receiver realms 104, respectively, that are recipients of cross-realm communications from the sender realm 102. A realm-specific key pair includes a realm-specific private key that can be utilized to secure data and a realm-specific public key that can be utilized to access data. The sender cross-realm service 106 can generate a digital signature utilizing a realm-specific private key of a realm-specific key pair. The receiver cross-realm service 110 can validate the digital signature utilizing a realm-specific public key of the realm-specific key pair. Additionally, or alternatively, the sender cross-realm service 106 can encrypt data utilizing a realm-specific private key of a realm-specific key pair. The receiver cross-realm service 110 can decrypt the encrypted data utilizing a realm-specific public key of the realm-specific key pair.

The receiver realm 104 includes a public key repository 134. The public key repository 134 includes public keys that can be utilized by the receiver cross-realm service 110 to access messages transmitted to the receiver realm 104 over various cross-realm communication channels. The public key repository 134 may include pipeline-specific public keys and/or realm-specific public keys. The sender cross-realm service 106 may transmit a pipeline-specific public key to the receiver cross-realm service 110 when initializing a cross-realm communication channel. The receiver cross-realm service 110 may store the pipeline-specific public key in the public key repository 134 in association with a particular sender pipeline 118 and/or receiver pipeline 128 corresponding to the pipeline-specific public key. A realm-specific public key may be stored in the public key repository 134 during a provisioning process for the receiver realm 104. Additionally, or alternatively, the realm-specific public key may be stored in the public key repository 134 during a provisioning process for the receiver cross-realm service 110. Additionally, or alternatively, the sender cross-realm service 106 may transmit a realm-specific public key to the receiver cross-realm service 110 when initializing a cross-realm communication channel. The receiver cross-realm service 110 may store the realm-specific public key in the public key repository 134 in association with a particular sender realm 102.

The sender realm 102 may include a sender user device interface 140 that is communicatively coupled or couplable with one or more components of the sender realm 102. The receiver realm 104 may include a receiver user device interface 142 that is communicatively coupled or couplable with one or more components of the receiver realm 104. A user device interface, such as the sender user device interface 140 and/or the receiver user device interface 142, may include hardware and/or software configured to facilitate interactions between a user and various aspects of the system. The user device interface may render user interface elements and receive input via user interface elements. Examples of interfaces include a graphical user interface (GUI), a command line interface (CLI), a haptic interface, or a voice command interface. Examples of user interface elements include checkboxes, radio buttons, dropdown lists, list boxes, buttons, toggles, text fields, date and time selectors, command lines, sliders, pages, or forms. Any one or more of these interfaces or interface elements may be utilized by the user device interface.

In an embodiment, different components of a user device interface are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, a user device interface may be specified in one or more other languages, such as Java, C, or C++.

Various components of the system 100 may communicate with one another via one or more communications interfaces. For example, a sender communications interface 144 may be communicatively coupled or couplable with one or more components of the sender realm 102. Additionally, or alternatively, a receiver communications interface 146 may be communicatively coupled or couplable with one or more components of the receiver realm 104. The one or more communications interfaces may include hardware and/or software configured to transmit data between respective components of the system 100 and/or to transmit data to and/or from the system 100.

In an embodiment, one or more components of the system 100 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 3. Example Operations for Transferring Data from a Sender Realm to a Receiver Realm

Referring to FIGS. 2A-2C, FIGS. 3A-3C, FIGS. 4A and 4B, and FIGS. 5A-5C, example operations are further described. One or more operations described with reference to FIGS. 2A-2C, FIGS. 3A-3C, FIGS. 4A and 4B, and FIGS. 5A-5C, may be modified, rearranged, or omitted. Accordingly, the particular sequence of operations described with reference to FIGS. 2A-2C, FIGS. 3A-3C, FIGS. 4A and 4B, and FIGS. 5A-5C should not be construed as limiting the scope of one or more embodiments. In one example, the operations described with reference to FIGS. 2A-2C, FIGS. 3A-3C, FIGS. 4A and 4B, and FIGS. 5A-5C may be performed by one or more features of the system described with reference to FIG. 1.

As described with reference to FIGS. 2A-2C, a system configures a cross-realm communication channel for transferring data from a low realm to a high realm. Cross-realm communications from the low realm to the high realm are associated with a restriction level that differs from a restriction level for cross-realm communications from the high realm to the low realm. The restriction level for cross-realm communications from the high realm to the low realm may include a restriction on data egress from the high realm. The system generates a mapping, stored in the high realm, between a sender pipeline deployed in the low realm and a receiver pipeline deployed in a high realm. The system utilizes the mapping to transfer data from the sender pipeline to the receiver pipeline based on a sender pipeline identifier without identifying the receiver pipeline outside the high realm. In one example, entities in the low realm do not have access to any identifying information of the receiver pipeline, for example, because entities in the low realm do not have access to the high realm. Additionally, or alternatively, entities in the low realm may not have access to any mapping between any pipeline in the low realm and any pipeline in the high realm, for example, because no such mapping exists in the low realm, and the entities in the low realm do not have access to any mappings in the high realm.

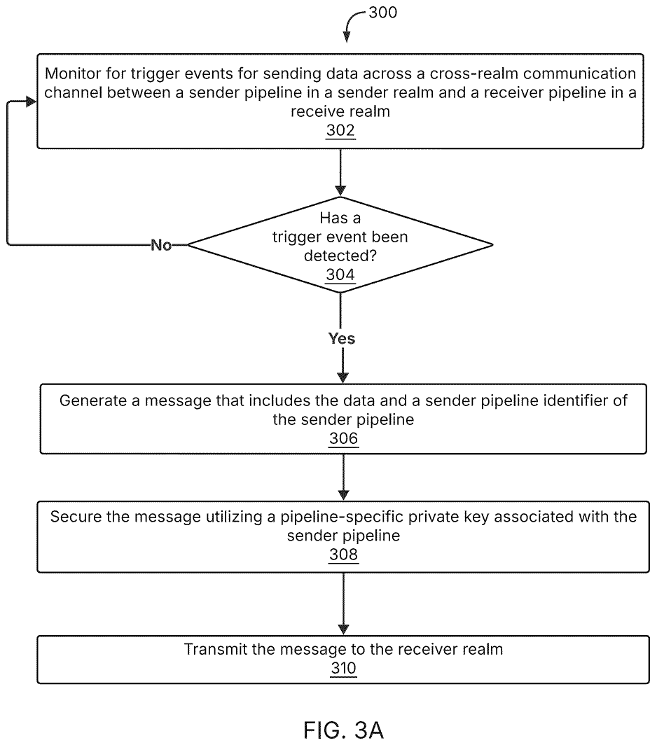

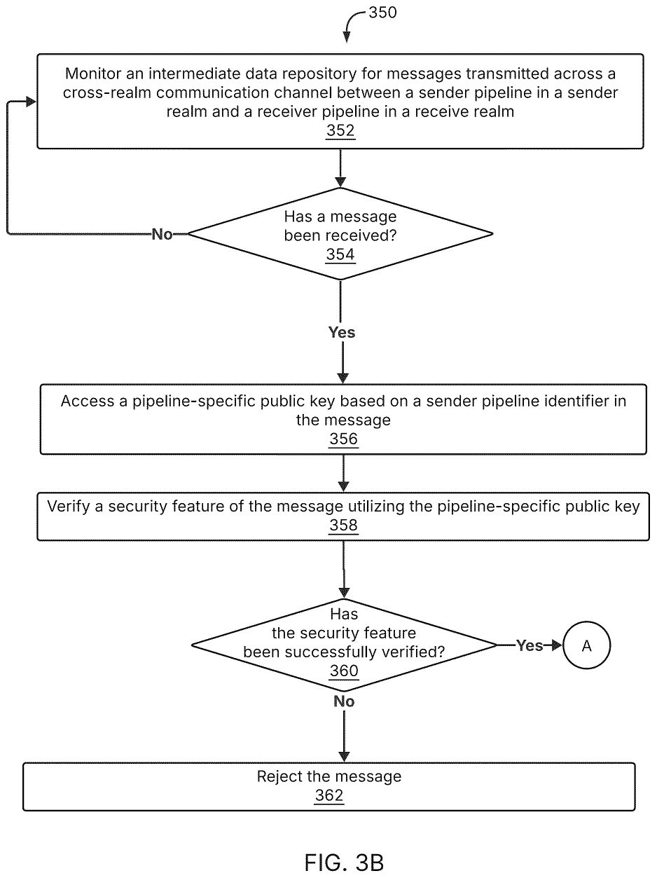

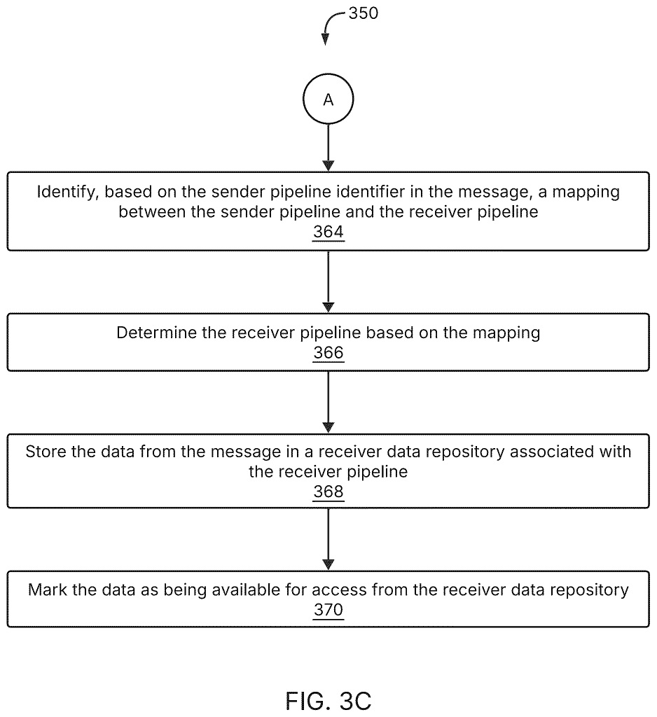

As described with reference to FIGS. 3A-3C, the system utilizes the cross-realm communication channel configured as described with reference to FIGS. 2A-2C for data transmissions, such as unidirectional data transmissions, from the low realm to the high realm. In one example, no information from the high realm is transmitted to the low realm over the cross-realm communication channel. Because entities in the low realm do not have access to identifying information of the receiver pipeline in the high realm, the system identifies messages transmitted from the low realm with a pipeline identifier of the sender pipeline in the low realm. When the system receives a message in the high realm, the system determines the receiver pipeline corresponding to the sender pipeline based on the mapping of the receiver pipeline to the sender pipeline in the high realm.

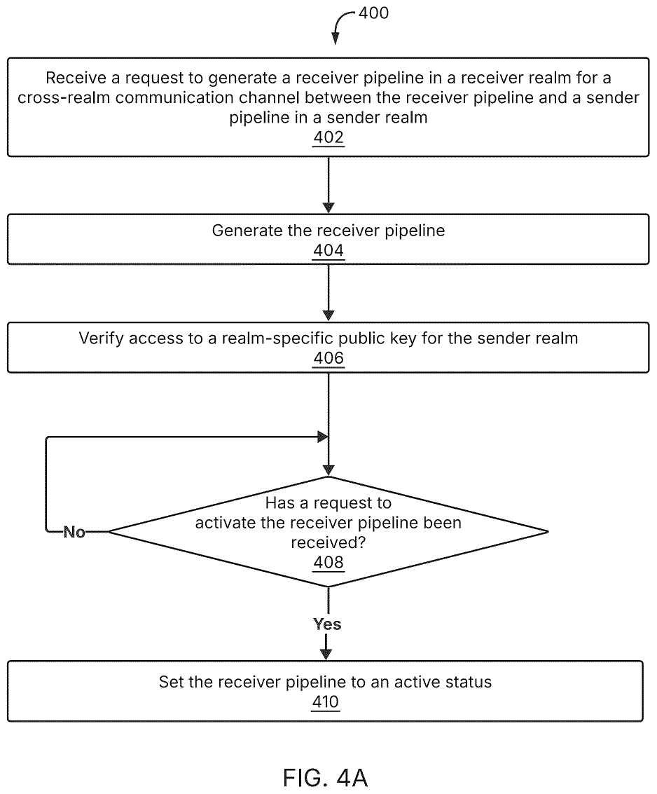

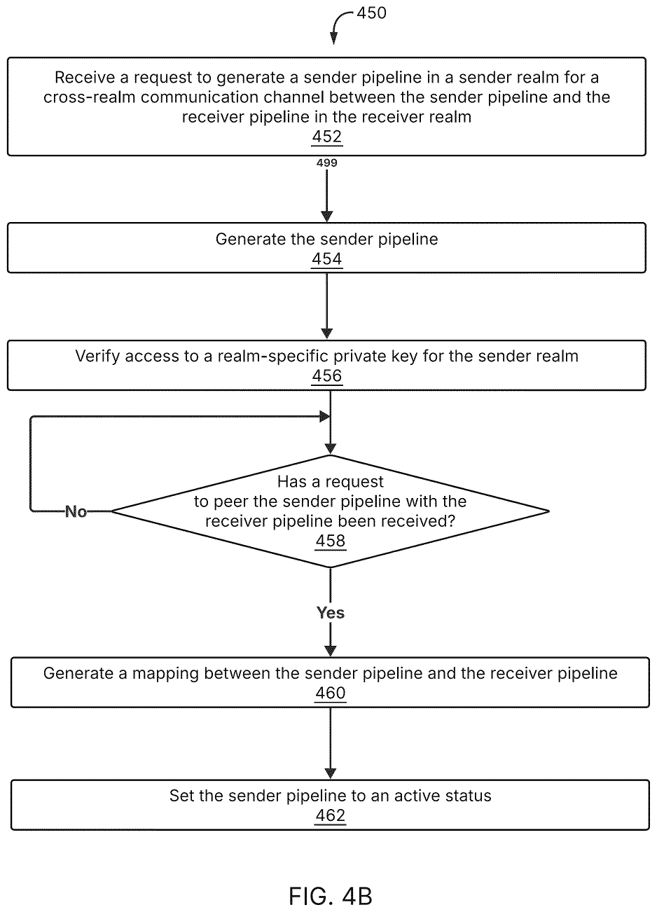

As described with reference to FIGS. 4A and 4B, a system configures a cross-realm communication channel for transferring data from a high realm to a low realm. Cross-realm communications from the high realm to the low realm are associated with a restriction level that differs from a restriction level for cross-realm communications from the low realm to the high realm. The restriction level for cross-realm communications from the high realm to the low realm may include a restriction on data egress from the high realm. The system generates a mapping, stored in the high realm, between a receiver pipeline deployed in the low realm and a sender pipeline deployed in a high realm. The system utilizes the mapping to transfer data from the sender pipeline to the receiver pipeline based on a receiver pipeline identifier without identifying the sender pipeline outside the high realm. In one example, entities in the low realm do not have access to any identifying information of the sender pipeline, for example, because entities in the low realm do not have access to the high realm. Additionally, or alternatively, entities in the low realm may not have access to any mapping between any pipeline in the high realm and any pipeline in the low realm, for example, because no such mapping exists in the low realm, and the entities in the low realm do not have access to any mappings in the high realm.

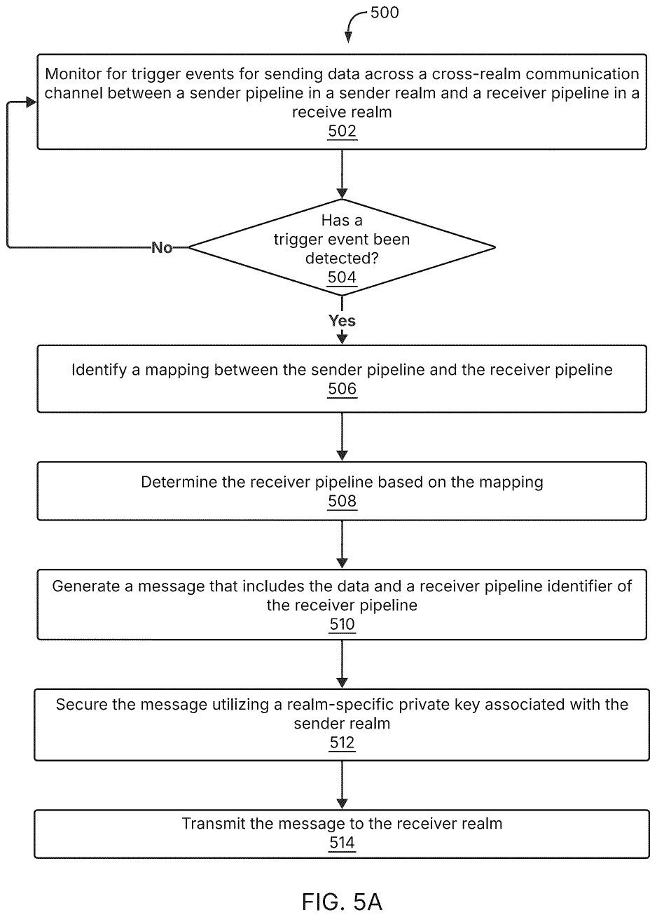

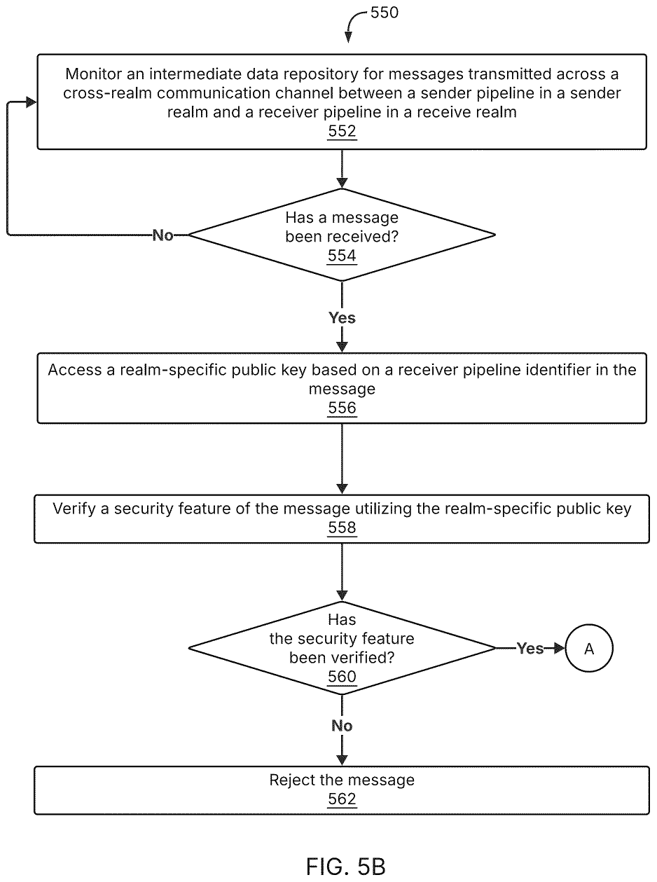

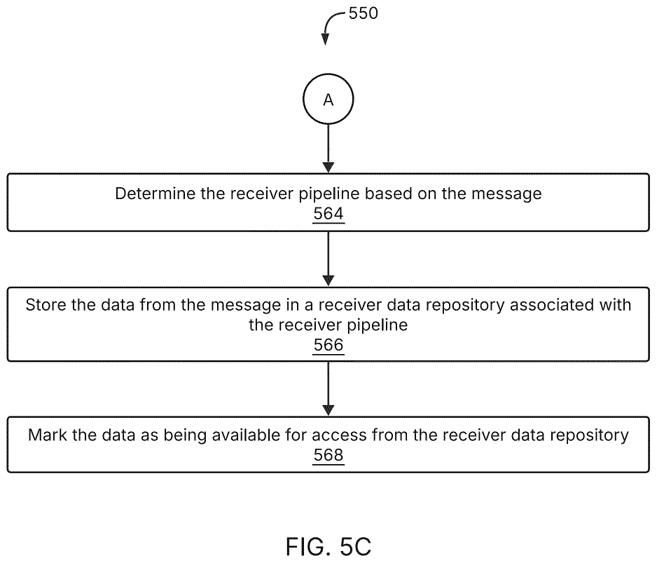

As described with reference to FIGS. 5A-5C, the system utilizes the cross-realm communication channel configured as described with reference to FIGS. 4A and 4B for data transmissions, such as unidirectional data transmissions, from the high realm to the low realm. In one example, no information from the low realm is transmitted to the high realm over the cross-realm communication channel. Because entities in the low realm do not have access to identifying information of the sender pipeline in the high realm, the system identifies messages transmitted from the high realm with a pipeline identifier of the receiver pipeline in the low realm. When the system receives a message in the low realm, the system determines the receiver pipeline based on the pipeline identifier of the receiver pipeline included in the message.

### A. Configuring a Cross-Realm Communication Channel for Transferring Data from a Low Realm to a High Realm

Referring to FIGS. 2A-2C, operations pertaining to configuring a cross-realm communication channel for transferring data from a low realm to a high realm are further described. In one example, operations 200 described with reference to FIG. 2A are executed within a sender realm. Additionally, or alternatively, operations 250 described with reference to FIGS. 2B and 2C are executed within a receiver realm. In one example, a system executes the operations described with reference to FIGS. 2A-2C to configure a cross-realm communication channel for transferring data from a low realm to a high realm, for example, when a restriction level for cross-realm communications from the high realm to the low realm is higher than a restriction level for cross-realm communications from the low realm to the high realm. In one example, no information is transmitted to the low realm over the cross-realm communication channel configured as described with reference to FIGS. 2A-2C.

As shown in FIG. 2A, a system receives a request to generate a sender pipeline in a sender realm for a cross-realm communication channel between the sender pipeline and a receiver pipeline in a receiver realm (Operation 202). The request to generate the sender pipeline can be initiated from a user device and/or from an entity within the sender realm such as an entity in a sender tenancy of the sender realm. The system may receive the request via an application programming interface (API) or a CLI. In one example, the request is received from a user that is authenticated in the sender realm such as in the sender tenancy of the sender realm. In one example, the system receives the request on the basis of a user principal. The user principal is granted responsive to an authentication performed in the sender realm. In one example, the request is received by a cross-realm service located in the sender realm.

The system generates the sender pipeline in response to the request (Operation 204). In one example, the system generates the sender pipeline in the sender tenancy of the sender realm. The sender pipeline will be utilized for sending data over a cross-realm communication channel to a receiver realm. The system may generate the sender pipeline via an API call. The system may generate the sender pipeline based on a blueprint that includes code, libraries, and frameworks. The system provisions infrastructure that will be utilized by the sender pipeline, defines configuration settings for the sender pipeline, and deploys the sender pipeline for utilization in the sender realm. The system may deploy the sender pipeline to a virtual machine, container, and/or serverless function in the sender realm. The system assigns a sender pipeline identifier to the sender pipeline. Additionally, the system defines a mapping relationship between the sender pipeline and a sender data storage unit corresponding to the sender pipeline.

In one example, the system generates the sender data storage unit in response to the request to generate the sender pipeline. Additionally, or alternatively, the system may generate the sender data storage unit in response to a separate request. The request to generate the sender pipeline may include a storage unit identifier of the sender data storage unit. Additionally, or alternatively, the system may determine the storage unit identifier when generating the sender data storage unit in response to the request to generate the sender pipeline. The system may generate the sender data storage unit in the sender tenancy of the sender realm. The system may generate the sender data storage unit via an API call. The system allocates storage space within a storage infrastructure for the sender data storage unit and assigns a sender data storage unit identifier to the sender data storage unit. The storge space may be dynamically scalable as objects are added to the sender data storage unit. In one example, an object storage service generates the sender data storage unit. After generating the sender pipeline and the sender data storage unit, the system outputs the sender pipeline identifier and/or the sender data storage unit identifier for use in subsequent operations.

The system generates a pipeline-specific key pair for the sender pipeline (Operation 206). The pipeline-specific key pair includes a public key and a private key. The system associates the pipeline-specific key pair with the sender pipeline. In one example, after the system generates the sender pipeline, the system asynchronously generates the pipeline-specific key pair and associates the pipeline-specific key pair with the sender pipeline. The system may utilize the pipeline-specific key pair exclusively for data transmitted over the cross-realm communication channel between the sender pipeline and the receiver pipeline. The system utilizes the private key of the pipeline-specific key pair to secure data transferred from the sender realm to the receiver realm via the sender pipeline. For example, the system may generate a digital signature utilizing the private key. Additionally, or alternatively, the system may encrypt data for transfer over the cross-realm communication channel. The system utilizes the public key to access data transferred over the cross-realm communication channel. For example, the system may utilize the public key to validate a digital signature that was generated by the private key and access the data responsive at least in part to validating the digital signature. Additionally, or alternatively, the system may decrypt data that was encrypted by the private key and access the data responsive at least in part to decrypting the encrypted data.

The system may associate the pipeline-specific key pair with the sender pipeline by specifying the pipeline-specific key pair and/or the private key of the pipeline-specific key pair that should be utilized to secure data associated with the sender pipeline, for example, in configuration settings of the sender pipeline. The system may store the pipeline-specific key pair and/or the private key of the pipeline-specific key pair in a particular location such as in a key repository accessible by a cross-realm service associated with the sender pipeline. The configuration settings of the sender pipeline may include a location of the key repository where the pipeline-specific key pair and/or the private key of the pipeline-specific key pair are stored. Additionally, or alternatively, the configuration settings of the sender pipeline may include a key identifier corresponding to the pipeline-specific key pair and/or the private key of the pipeline-specific key pair. In one example, the system utilizes the sender pipeline identifier as the “name” of a key file, for example, to associate the pipeline-specific key pair and/or the private key of the pipeline-specific key pair with the sender pipeline.

The system transmits the sender pipeline identifier of the sender pipeline and the public key of the pipeline-specific key pair to the receiver realm (Operation 208). In one example, the system generates a control message that includes the sender pipeline identifier and the public key of the pipeline-specific key pair. The system may utilize a sender gateway to transmit the sender pipeline identifier and the public key to the receiver realm. The sender gateway may transmit the sender pipeline identifier and the public key to a receiver gateway in the receiver realm. The sender gateway may be located in a service tenancy of the sender realm. The system transmits the control message to the receiver realm. The term “control message” refers to a message for managing or coordinating system behavior rather than transporting application data. Transmission of the sender pipeline identifier and the public key, for example, via a control message, is compliant with a restriction level of the sender realm for cross-realm communications from the sender realm to the receiver realm. In one example, transmission of public key information from the sender realm to the receiver realm as application data would be non-compliant with the restriction level of the sender realm. Additionally, or alternatively, transmission of public key information from the receiver realm to the sender realm would be non-compliant with a restriction level of the receiver realm for cross-realm communications from the receiver realm to the sender realm. A cross-realm service in the receiver realm receives the sender pipeline identifier of the sender pipeline and the public key of the pipeline-specific key pair and stores the sender pipeline identifier and the public key in the receiver realm, as further described below with reference to FIG. 2B.

After transmitting the sender pipeline identifier and the public key to the receiver realm, the system sets the sender pipeline to an inactive status. The system may define the status of the sender pipeline in metadata associated with the sender pipeline. The inactive status may indicate that the sender pipeline has yet to be activated. The system awaits a request to activate the sender pipeline. In one example, prior to receiving the request to activate the sender pipeline, the system executes operations 250 associated with configuring a receiver pipeline for the cross-realm communication channel as described with reference to FIGS. 2B and 2C.

The system determines whether a request to activate the sender pipeline has been received (Operation 210). The request to activate the sender pipeline may be provided via a user input. The system may await the user input. Additionally, or alternatively, the system may periodically check an input buffer for the request or the system may receive a notification when the request is received. When the request to activate the sender pipeline has not yet been received, the system awaits the request.

When the system receives the request to activate the sender pipeline, the system sets the sender pipeline to an active status (Operation 212). To activate the sender pipeline, the system updates the status of the sender pipeline in metadata associated with the sender pipeline to indicate that the sender pipeline is active. When the sender pipeline has an active status, the system may commence transferring data over the cross-realm communication channel between the sender pipeline and the receiver pipeline. In one example, the request to activate the sender pipeline occurs subsequent to activating the receiver pipeline. In one example, the system presumes that the receiver pipeline is active based on receiving the request to activate the sender pipeline. The system may receive the request to activate the sender pipeline via a user input. The request to activate the sender pipeline, such as the user input, does not identify the receiver pipeline for the cross-realm communication channel between the sender pipeline and the receiver pipeline. For example, the receiver pipeline may be identifiable with a receiver pipeline identifier, and the receiver pipeline identifier remains within the receiver realm. Additionally, or alternatively, activating the sender pipeline does not include storing any mapping in the sender realm between the sender pipeline and the receiver pipeline. Additionally, or alternatively, activating the sender pipeline does not include identifying the receiver pipeline outside the receiver realm.

Referring to FIGS. 2B and 2C, operations 250 pertaining to configuring a receiver pipeline for a cross-realm communication channel are further described. The receiver pipeline configured based on the operations 250 described with reference to FIGS. 2B and 2C is utilized for a cross-realm communication channel for transferring data from a low realm to a high realm.

As shown in FIG. 2B, a system in a receiver realm receives a request to generate a receiver pipeline in the receiver realm for the cross-realm communication channel between the receiver pipeline and the sender pipeline in a sender realm (Operation 252). The request to generate the receiver pipeline can be initiated from a user device and/or from an entity within the receiver realm such as an entity in a receiver tenancy of the receiver realm. The system may receive the request via an API or a CLI. In one example, the request is received from a user that is authenticated in the receiver realm such as in the receiver tenancy of the receiver realm. In one example, the system receives the request on the basis of a user principal. The user principal is granted responsive to an authentication performed in the receiver realm. In one example, the request is received by a cross-realm service located in the receiver realm.

The system generates the receiver pipeline in response to the request (Operation 254). In one example, the system generates the receiver pipeline in the receiver tenancy of the receiver realm. The receiver pipeline will be utilized for receiving data transmitted over the cross-realm communication channel from the sender realm. The system may generate the receiver pipeline via an API call. The system may generate the receiver pipeline based on a blueprint that includes code, libraries, and frameworks. The system provisions infrastructure that will be utilized by the receiver pipeline, defines configuration settings for the receiver pipeline, and deploys the receiver pipeline for utilization in the receiver realm. The system may deploy the receiver pipeline to a virtual machine, container, and/or serverless function in the receiver realm. The system assigns a receiver pipeline identifier to the receiver pipeline. Additionally, the system defines a mapping relationship between the receiver pipeline and a receiver data storage unit corresponding to the receiver pipeline. After generating the receiver pipeline, the system sets the receiver pipeline to an inactive status. The system may define the status of the receiver pipeline in metadata associated with the receiver pipeline. The inactive status may indicate that the receiver pipeline has yet to be activated. The system awaits a request to activate the receiver pipeline.

In one example, the system generates the receiver data storage unit in response to the request to generate the receiver pipeline. Additionally, or alternatively, the system may generate the receiver data storage unit in response to a separate request. The request to generate the receiver pipeline may include a storage unit identifier of the receiver data storage unit. Additionally, or alternatively, the system may determine the storage unit identifier when generating the receiver data storage unit in response to the request to generate the receiver pipeline. The system may generate the receiver data storage unit in the receiver tenancy of the receiver realm. The system may generate the receiver data storage unit via an API call. The system allocates storage space within a storage infrastructure for the receiver data storage unit and assigns a receiver data storage unit identifier to the receiver data storage unit. The storge space may be dynamically scalable as objects are added to the receiver data storage unit. In one example, an object storage service generates the receiver data storage unit. After generating the receiver pipeline and the receiver data storage unit, the system outputs the receiver pipeline identifier and/or the receiver data storage unit identifier for use in subsequent operations.

The system determines whether the sender pipeline identifier and the pipeline-specific public key for the sender pipeline have been received (Operation 256). The sender pipeline identifier and the pipeline-specific public key may be transmitted to the receiver realm at operation 208, for example, via a control message. The system may receive the sender pipeline identifier and the pipeline-specific public key for the sender pipeline asynchronously from the request to generate the receiver pipeline in the receiver realm. In one example, the system receives the sender pipeline identifier and the pipeline-specific public key for the sender pipeline prior to the request to generate the receiver pipeline. The system awaits receipt of the sender pipeline identifier and the pipeline-specific public key. When the sender pipeline identifier and the pipeline-specific public key have not yet been received, the system continues waiting. The system may periodically check an input buffer for receipt of the sender pipeline identifier and the pipeline-specific public key. Additionally, or alternatively, the system may receive a notification when the sender pipeline identifier and the pipeline-specific public key are received.

When the system determines that the pipeline identifier and the pipeline-specific public key have been received, the system stores the pipeline-specific public key in a public key repository (Operation 258). The system stores the pipeline-specific public key in association with the pipeline identifier of the sender pipeline. Additionally, or alternatively, the system may store the pipeline-specific public key in association with a pipeline identifier of the receiver pipeline for the cross-realm communication channel. In one example, the system generates a mapping between the pipeline-specific public key and at least one of either the pipeline identifier of the sender pipeline or the pipeline identifier of the receiver pipeline. In one example, the system stores the pipeline-specific public key in the public key repository, for example, in association with the pipeline identifier of the sender pipeline and awaits a request to peer the receiver pipeline with the sender pipeline.

As shown in FIG. 2C, the system determines whether a request has been received to peer the receiver pipeline with the sender pipeline (Operation 260). When the request to peer the sender pipeline with the receiver pipeline has not yet been received, the system awaits the request. The request to peer the receiver pipeline with the sender pipeline may be provided via a user input. The system may await the user input. Additionally, or alternatively, the system may periodically check an input buffer for the request or the system may receive a notification when the request is received.

When the system receives the request to peer the receiver pipeline with the sender pipeline, the system accesses the pipeline-specific public key in the public key repository based on the sender pipeline identifier in the request (Operation 262). In one example, the request to peer the receiver pipeline with the sender pipeline includes a partial pipeline identifier of the receiver pipeline and/or a partial pipeline identifier of the sender pipeline. The partial pipeline identifier may include a first string of characters that represents a first subset of a whole identifier of the pipeline. The partial pipeline identifier does not include a second string of characters representing a second subset of the whole identifier of the pipeline. The pipeline-specific public key may be stored in association with the whole pipeline identifier or a partial pipeline identifier. The system identifies the pipeline-specific public key based on the pipeline identifier in the request. For example, the system may identify a pipeline-specific public key that is stored in association with a whole or partial pipeline identifier that includes the first string of characters.

After identifying the pipeline-specific public key, the system associates the pipeline-specific public key with the receiver pipeline (Operation 264). The system may identify the pipeline-specific public key in configuration settings of the receiver pipeline. The configuration settings may include a location of a key repository where the pipeline-specific public key is stored. Additionally, or alternatively, the configuration settings may include a key identifier corresponding to the pipeline-specific public key. In one example, the system utilizes the sender pipeline identifier as the “name” of a key file, for example, to associate the pipeline-specific public key with the sender pipeline. In one example, a mapping between the sender pipeline and the receiver pipeline associates the pipeline-specific public key with the receiver pipeline.

The system generates the mapping between the receiver pipeline and the sender pipeline (Operation 266). The mapping may include a receiver pipeline identifier of the receiver pipeline and a sender pipeline identifier of the sender pipeline. The system may add the mapping between the receiver pipeline and the sender pipeline to a set of pipeline mappings stored in the receiver realm. The system stores the mappings in a data repository accessible to the cross-realm service in the receiver realm. In one example, the system maintains a mapping file that includes mappings between various sender pipelines and receiver pipelines. The system periodically updates the mapping file as mappings are added or removed for different cross-realm communication channels.

After generating the mapping, the system sets the receiver pipeline to an active status (Operation 268). The system may set the receiver pipeline to an active status in response to a user input and/or in response to generating the mapping. The active status indicates that the receiver pipeline is currently peered with the sender pipeline. The system may specify the active status of the receiver pipeline in metadata associated with the receiver pipeline. To activate the receiver pipeline, the system updates the status of the receiver pipeline in metadata associated with the receiver pipeline to indicate that the receiver pipeline is active. When the receiver pipeline has an active status, the system may commence receiving data over the cross-realm communication channel between the sender pipeline and the receiver pipeline. In one example, activation of the receiver pipeline occurs prior to activating the sender pipeline. In one example, activation of the receiver pipeline represents an indication that the sender pipeline is active.

### B. Transferring Data Over a Cross-Realm Communication Channel from a Low Realm to a High Realm

Referring to FIGS. 3A-3C, operations pertaining to transferring data over a cross-realm communication channel from a low realm to a high realm are further described. As described with reference to FIG. 3A, a system may execute operations 300 within a sender realm. As described with reference to FIGS. 3B and 3C, a system may execute operations 350 within a receiver realm. In one example, the high realm has a restriction level for cross-realm communications from the high realm to the low realm that is higher than a restriction level for cross-realm communications from the low realm to the high realm. Based at least on the restriction level for the high realm, the system transmits data over the cross-realm communication channel between the sender pipeline and the receiver pipeline based on a mapping between the sender pipeline and the receiver pipeline stored in the receiver realm without identifying the receiver pipeline outside the receiver realm.

As shown in FIG. 3A, a system monitors for trigger events for sending data across the cross-realm communication channel between a sender pipeline in a sender realm and a receiver pipeline in a receive realm (Operation 302). In one example, a trigger event for sending data across the cross-realm communication channel includes the system determining that data has been added to a sender data storage unit. A cross-realm service in the sender realm may monitor the sender data storage unit for data that is added to the sender data storage unit. Additionally, or alternatively, the system may provide a notification to the cross-realm service when data is added to the sender data storage unit. In one example, when the system determines that data has been added to the sender data storage unit, the system generates a trigger event corresponding to the data added to the sender data storage unit. The trigger event identifies the data and the sender data storage unit where the data is located. In one example, after generating the trigger event, the system adds the trigger event to an event queue.

The system determines whether a trigger event has been detected (Operation 304). The system may monitor the event queue for trigger events. Additionally, or alternatively, the system may provide a notification to the cross-realm service when a trigger event is added to the event queue. The event queue may include multiple trigger events. The cross-realm service may process the trigger events in a defined order such as in a sequential order. When the system determines that a trigger event has not been detected, the system continues monitoring the event queue or awaits a notification.

When the system determines that a trigger event is detected, the system generates a message that includes the data and a sender pipeline identifier of the sender pipeline (Operation 306). In one example, the data in the sender data storage unit includes a file. The system obtains the file from the sender data storage unit. The system generates a manifest that includes the sender pipeline identifier of the sender pipeline. The sender pipeline identifier is utilized to identify the cross-realm communication channel for transferring the message to the receiver realm.

The system secures the message utilizing a pipeline-specific private key associated with the sender pipeline (Operation 308). In one example, the system utilizes the pipeline-specific private key to generate a security feature. The security feature may include a digital signature over at least a portion of the message. In one example, the system digitally signs the manifest. Additionally, or alternatively, the security feature may include encrypting the data and/or the message for transmission over the cross-realm communication channel. The system may utilize the pipeline-specific private key to encrypt the data and/or the message. The system may exclusively utilize the pipeline-specific key pair for securing data for transmission over the cross-realm communication channel.

After securing the message utilizing the pipeline-specific private key, the system transmits the message to the receiver realm (Operation 310). The cross-realm service may initiate transmission of the message by directing the message to a sender gateway. The sender gateway may be located in a service tenancy of the sender realm. The sender gateway may transmit the message to a receiver gateway in the receiver realm. When the receiver gateway receives the message, the receiver gateway may store the message in an intermediate data repository in the receiver realm.

As shown in FIG. 3B, a system monitors the intermediate data repository for messages transmitted across the cross-realm communication channel (Operation 352). A cross-realm service in the receiver realm may monitor the intermediate data repository for messages added to the intermediate data repository. Additionally, or alternatively, the system may provide a notification to the cross-realm service when messages are added to the intermediate data repository. In one example, when a message is added to the intermediate data repository, the system adds a message event to an event queue. The system may monitor the event queue for message events. Additionally, or alternatively, the system may provide a notification to the cross-realm service when an message event is added to the event queue. The event queue may include multiple message events. The cross-realm service may process the message events in a defined order such as in a sequential order. When the system determines that a message event has not been detected, the system continues monitoring the event queue or awaits a notification.

The system determines whether a message has been received (Operation 354). When the system determines that a message has not been received, the system awaits receipt of a message. When the system determines that a message has been received, the system accesses the message and processes the message.

The system accesses a pipeline-specific public key based on a sender pipeline identifier in the message (Operation 356). The system utilizes the pipeline-specific public key to access data, such as a file, in the message. The system may parse the message to determine the sender pipeline identifier. The message may include a manifest. The sender pipeline identifier may be included in the manifest. The system may determine the sender pipeline identifier based on the manifest. The system may locate the pipeline-specific public key based on a mapping of the sender pipeline identifier to the pipeline-specific public key. Additionally, or alternatively, the system may locate the pipeline-specific public key based on a mapping of the pipeline-specific public key to a receiver pipeline identifier. The system may determine the receiver pipeline identifier based on a mapping of the sender pipeline identifier to the receiver pipeline identifier. In one example, the sender pipeline identifier includes a first string of characters representing a first subset of a whole identifier of the sender pipeline. The sender pipeline identifier does not include a second string of characters representing a second subset of the whole identifier of the sender pipeline. The pipeline-specific public key may be stored in association with the whole pipeline identifier. The system may identify the pipeline-specific public key in a data repository based on the sender pipeline identifier. The system may determine that the whole identifier includes the first string of characters of the sender pipeline identifier.

The system verifies a security feature of the message utilizing the pipeline-specific public key (Operation 358). The system may access data, such as a file, in the message in response to successfully verifying the security feature of the message. In one example, the security feature includes a digital signature that was generated utilizing the pipeline-specific private key. The system may validate the digital signature utilizing the pipeline-specific public key. Additionally, or alternatively, the security feature may include an encryption of the message or data contained within the message. The system may decrypt the encryption utilizing the pipeline-specific public key. Additionally, or alternatively, the security feature may include a set of pipeline identifying elements in the pipeline-specific public key. The system may verify that the sender pipeline identifier in the manifest corresponds to the set of pipeline identifying elements in the pipeline-specific public key. The system may determine that the message is associated with the sender pipeline based on determining that the set of pipeline identifying elements in the pipeline-specific public key correspond to the pipeline identifier in the manifest.

The system determines whether the security feature has been successfully verified (Operation 360). If the security feature is not successfully verified, the system rejects the message (Operation 362). To reject the message, the system may delete the message from the intermediate data repository. Additionally, or alternatively, the system may refrain from transferring the message to a receiver data storage unit associated with the receiver pipeline.

As shown in FIG. 3C, the system identifies a mapping between the sender pipeline and the receiver pipeline based on the sender pipeline identifier in the message (Operation 364). The system may access a set of pipeline mappings. The system may identify the mapping between the sender pipeline and the receiver pipeline in the set of pipeline mappings based on the sender pipeline identifier. The set of pipeline mappings may include multiple mappings between different sender pipelines and receiver pipelines. The mappings include a sender pipeline field mapped to a receiver pipeline field. The sender pipeline field includes a first string of characters identifying the sender pipeline. The receiver pipeline field includes a second string of characters identifying the receiver pipeline.

The system determines the receiver pipeline that is mapped to the sender pipeline in the message based on the mapping between the sender pipeline and the receiver pipeline (Operation 366). The system may identify a mapping that includes a sender pipeline identifier that matches the sender pipeline identifier in the message. The system may identify a mapping with a sender pipeline field that includes a first string of characters corresponding to the sender pipeline identifier in the message. The system may determine a second string of characters in the receiver pipeline field mapped to the sender pipeline field. The system may determine a receiver pipeline identifier that corresponds to the second string of characters in the receiver pipeline field.

After determining the receiver pipeline, the system stores the data, such as the file, from the message in a receiver data storage unit associated with the receiver pipeline (Operation 368). The receiver data storage unit may be designated for receiving files transmitted to the receiver pipeline over the communication channel. The system may identify the receiver data storage unit based on metadata associated with the receiver pipeline. The receiver data storage unit may be mapped to the receiver pipeline in the metadata. The system transmits the data, such as the file, to the receiver data storage unit.

After transmitting the data to the receiver data storage unit, the system marks the data as being available for access from the receiver data storage unit (Operation 370). The system may mark the data as available for access by updating metadata associated with the receiver data storage unit. Additionally, or alternatively, the system may generate a notification that the data is available for access from the receiver data storage unit. The system may render a display on a GUI indicating that the data is available for access from the receiver data storage unit.

### C. Configuring a Cross-Realm Communication Channel for Transferring Data from a High Realm to a Low Realm

Referring to FIGS. 4A and 4B, operations pertaining to configuring a cross-realm communication channel for transferring data from a high realm to a low realm are further described. In one example, operations 400 described with reference to FIG. 4A are executed within a sender realm. Additionally, or alternatively, operations 450 described with reference to FIG. 4B are executed within a receiver realm.

In one example, a system executes the operations described with reference to FIGS. 4A and 4B to configure a cross-realm communication channel for transferring data from a high realm to a low realm, for example, when a restriction level for cross-realm communications from the high realm to the low realm is higher than a restriction level for cross-realm communications from the low realm to the high realm. In one example, no information is transmitted to the high realm over the cross-realm communication channel configured as described with reference to FIGS. 4A and 4B.

As shown in FIG. 4A, a system receives a request to generate a receiver pipeline in a receiver realm for a cross-realm communication channel between the receiver pipeline and a sender pipeline in a sender realm (Operation 402). The request to generate the receiver pipeline can be initiated from a user device and/or from an entity within the receiver realm such as an entity in a receiver tenancy of the receiver realm. The system may receive the request via an API or a CLI. In one example, the request is received from a user that is authenticated in the receiver realm such as in the receiver tenancy of the receiver realm. In one example, the system receives the request on the basis of a user principal. The user principal is granted responsive to an authentication performed in the receiver realm. In one example, the request is received by a cross-realm service located in the receiver realm.

The system generates the receiver pipeline in response to the request (Operation 404). In one example, the system generates the receiver pipeline in the receiver tenancy of the receiver realm. The receiver pipeline will be utilized for receiving data transmitted over the cross-realm communication channel from the sender realm. The system may generate the receiver pipeline via an API call. The system may generate the receiver pipeline based on a blueprint that includes code, libraries, and frameworks. The system provisions infrastructure that will be utilized by the receiver pipeline, defines configuration settings for the receiver pipeline, and deploys the receiver pipeline for utilization in the receiver realm. The system may deploy the receiver pipeline to a virtual machine, container, and/or serverless function in the receiver realm. The system assigns a receiver pipeline identifier to the receiver pipeline. Additionally, the system defines a mapping relationship between the receiver pipeline and a receiver data storage unit corresponding to the receiver pipeline.

In one example, the system generates the receiver data storage unit in response to the request to generate the receiver pipeline. Additionally, or alternatively, the system may generate the receiver data storage unit in response to a separate request. The request to generate the receiver pipeline may include a storage unit identifier of the receiver data storage unit. Additionally, or alternatively, the system may determine the storage unit identifier when generating the receiver data storage unit in response to the request to generate the receiver pipeline. The system may generate the receiver data storage unit in the receiver tenancy of the receiver realm. The system may generate the receiver data storage unit via an API call. The system allocates storage space within a storage infrastructure for the receiver data storage unit and assigns a receiver data storage unit identifier to the receiver data storage unit. The storge space may be dynamically scalable as objects are added to the receiver data storage unit. In one example, an object storage service generates the receiver data storage unit. After generating the receiver pipeline and the receiver data storage unit, the system outputs the receiver pipeline identifier and/or the receiver data storage unit identifier for use in subsequent operations.

The system verifies access to a realm-specific public key for the sender realm (Operation 406). The realm-specific public key may be a realm-wide public key that is generally accessible to entities within the receiver realm. The realm-specific public key may be obtained and/or generated as part of a realm-specific key pair when provisioning the receiver realm. The system may verify access to the realm-specific public key by checking a public key repository for the realm-specific public key. The realm-specific public key may be identifiable based on a realm identifier that identifies the sender realm. In one example, the system generates the realm-specific key pair associated with the sender realm and transmits the realm-specific public key of the realm-specific key pair to the receiver realm. The system maintains the realm-specific private key within the sender realm. The system may utilize the realm-specific key pair for data transmitted over multiple cross-realm communication channels between the sender realm and the receiver realm.

The system utilizes the private key of the realm-specific key pair to secure data transferred from the sender realm to the receiver realm. For example, the system may generate a digital signature utilizing the private key. Additionally, or alternatively, the system may encrypt data for transfer over the cross-realm communication channel. The system utilizes the public key to access data transferred over the cross-realm communication channel. For example, the system may utilize the public key to validate a digital signature that was generated by the private key and access the data responsive at least in part to validating the digital signature. Additionally, or alternatively, the system may decrypt data that was encrypted by the private key and access the data responsive at least in part to decrypting the encrypted data.

The system may associate the realm-specific public key with the receiver pipeline by specifying, for example, in configuration settings of the receiver pipeline, that the realm-specific public key should be utilized to access data associated with the receiver pipeline. The configuration settings of the receiver pipeline may include a location of the key repository where the realm-specific public key is stored. Additionally, or alternatively, the configuration settings of the receiver pipeline may include a key identifier corresponding to the realm-specific public key.

The system determines whether a request to activate the receiver pipeline been received (Operation 408). The request to activate the receiver pipeline may be provided via a user input. The system may await the user input. Additionally, or alternatively, the system may periodically check an input buffer for the request, or the system may receive a notification when the request is received. When the request to activate the receiver pipeline has not yet been received, the system awaits the request.

When the system receives the request to activate the receiver pipeline, the system sets the receiver pipeline to an active status (Operation 410). To activate the receiver pipeline, the system updates the status of the receiver pipeline in metadata associated with the receiver pipeline to indicate that the receiver pipeline is active. When the receiver pipeline has an active status, the system may commence receiving data over the cross-realm communication channel between the sender pipeline and the receiver pipeline. In one example, the request to activate the receiver pipeline occurs subsequent to activating the sender pipeline. In one example, the system presumes that the sender pipeline is active based on receiving the request to activate the receiver pipeline. The system may receive the request to activate the receiver pipeline via a user input. The request to activate the receiver pipeline, such as the user input, does not identify the sender pipeline for the cross-realm communication channel between the sender pipeline and the receiver pipeline. For example, the sender pipeline may be identifiable with a sender pipeline identifier, and the sender pipeline identifier remains within the sender realm. Additionally, or alternatively, activating the receiver pipeline does not include storing any mapping in the receiver realm between the sender pipeline and the receiver pipeline. Additionally, or alternatively, activating the receiver pipeline does not include identifying the sender pipeline outside the sender realm.

Referring to FIG. 4B, operations 450 pertaining to configuring a sender pipeline for a cross-realm communication channel are further described. The sender pipeline configured based on the operations 450 described with reference to FIG. 4B is utilized for a cross-realm communication channel for transferring data from a high realm to a low realm.

As shown in FIG. 4B, a system in a sender realm receives a request to generate a sender pipeline in the sender realm for the cross-realm communication channel between the sender pipeline and the receiver pipeline in the receiver realm (Operation 452). The request to generate the sender pipeline can be initiated from a user device and/or from an entity within the sender realm such as an entity in a sender tenancy of the sender realm. The system may receive the request via an API or a CLI. In one example, the request is received from a user that is authenticated in the sender realm such as in the sender tenancy of the sender realm. In one example, the system receives the request on the basis of a user principal. The user principal is granted responsive to an authentication performed in the sender realm. In one example, the request is received by a cross-realm service located in the sender realm.

The system generates the sender pipeline in response to the request (Operation 454). In one example, the system generates the sender pipeline in the sender tenancy of the sender realm. The sender pipeline will be utilized for sending data over a cross-realm communication channel to a receiver realm. The system may generate the sender pipeline via an API call. The system may generate the sender pipeline based on a blueprint that includes code, libraries, and frameworks. The system provisions infrastructure that will be utilized by the sender pipeline, defines configuration settings for the sender pipeline, and deploys the sender pipeline for utilization in the sender realm. The system may deploy the sender pipeline to a virtual machine, container, and/or serverless function in the sender realm. The system assigns a sender pipeline identifier to the sender pipeline. Additionally, the system defines a mapping relationship between the sender pipeline and a sender data storage unit corresponding to the sender pipeline.

In one example, the system generates the sender data storage unit in response to the request to generate the sender pipeline. Additionally, or alternatively, the system may generate the sender data storage unit in response to a separate request. The request to generate the sender pipeline may include a storage unit identifier of the sender data storage unit. Additionally, or alternatively, the system may determine the storage unit identifier when generating the sender data storage unit in response to the request to generate the sender pipeline. The system may generate the sender data storage unit in the sender tenancy of the sender realm. The system may generate the sender data storage unit via an API call. The system allocates storage space within a storage infrastructure for the sender data storage unit and assigns a sender data storage unit identifier to the sender data storage unit. The storge space may be dynamically scalable as objects are added to the sender data storage unit. In one example, an object storage service generates the sender data storage unit. After generating the sender pipeline and the sender data storage unit, the system outputs the sender pipeline identifier and/or the sender data storage unit identifier for use in subsequent operations.

The system verifies access to a realm-specific private key for the sender realm (Operation 456). The realm-specific private key may be a realm-wide private key that is accessible to authorized entities within the sender realm. The system may designate a cross-realm service in the sender realm as an authorized entity for utilizing the realm-wide private key to secure data for transfer to the receiver realm. The realm-specific private key may be obtained and/or generated as part of a realm-specific key pair when provisioning the sender realm. The system may verify access to the realm-specific private key by checking a key repository for the realm-specific private key. The realm-specific private key may be identifiable based on a realm identifier that identifies the sender realm. In one example, the system generates the realm-specific key pair associated with the sender realm and transmits the realm-specific public key of the realm-specific key pair to the receiver realm. The system maintains the realm-specific private key within the sender realm. The system may utilize the realm-specific key pair for data transmitted over multiple cross-realm communication channels between the sender realm and the receiver realm.

The system utilizes the private key of the realm-specific key pair to secure data transferred from the sender realm to the receiver realm. For example, the system may generate a digital signature utilizing the private key. Additionally, or alternatively, the system may encrypt data for transfer over the cross-realm communication channel. The system may associate the realm-specific private key with the sender pipeline by specifying, for example, in configuration settings of the sender pipeline that the realm-specific private key should be utilized to secure data associated with the sender pipeline. In one example, the system generates a mapping between the realm-specific private key and the pipeline identifier of the sender pipeline. The configuration settings of the sender pipeline may include a location of the key repository where the realm-specific private key is stored. Additionally, or alternatively, the configuration settings of the sender pipeline may include a key identifier corresponding to the realm-specific private key.

The system determines whether a request has been received to peer the sender pipeline with the receiver pipeline (Operation 458). When the request to peer the sender pipeline with the receiver pipeline has not yet been received, the system awaits the request. The request to peer the sender pipeline with the receiver pipeline may be provided via a user input. The system may await the user input. Additionally, or alternatively, the system may periodically check an input buffer for the request or the system may receive a notification when the request is received.

When the system receives the request to peer the sender pipeline with the receiver pipeline, the system generates a mapping between the sender pipeline and the receiver pipeline (Operation 460). The mapping may include a receiver pipeline identifier of the receiver pipeline and a sender pipeline identifier of the sender pipeline. The system may add the mapping between the sender pipeline and the receiver pipeline to a set of pipeline mappings stored in the sender realm. The system stores the mappings in a data repository accessible to the cross-realm service in the sender realm. In one example, the system maintains a mapping file that includes mappings between various sender pipelines and receiver pipelines. The system periodically updates the mapping file as mappings are added or removed for different cross-realm communication channels.

After generating the mapping, the system sets the sender pipeline to an active status (Operation 462).

The system may set the sender pipeline to an active status in response to a user input and/or in response to generating the mapping. The active status indicates that the sender pipeline is currently peered with the receiver pipeline. The system may specify the active status of the sender pipeline in metadata associated with the sender pipeline. To activate the sender pipeline, the system updates the status of the sender pipeline in metadata associated with the sender pipeline to indicate that the sender pipeline is active. When the sender pipeline has an active status, the system may commence transferring data over the cross-realm communication channel between the sender pipeline and the receiver pipeline. In one example, activation of the sender pipeline occurs after to activating the receiver pipeline. In one example, activation of the sender pipeline represents an indication that the receiver pipeline is active.

### D. Transferring Data Over a Cross-Realm Communication Channel from a High Realm to a Low Realm

Referring to FIGS. 5A-5C, operations pertaining to transferring data over a cross-realm communication channel from a high realm to a low realm are further described. As described with reference to FIG. 5A, a system may execute operations 500 within a sender realm. As described with reference to FIGS. 5B and 5C, a system may execute operations 550 within a receiver realm. In one example, the high realm has a restriction level for cross-realm communications from the high realm to the low realm that is higher than a restriction level for cross-realm communications from the low realm to the high realm. Based at least on the restriction level for the high realm, the system transmits data over the cross-realm communication channel between the sender pipeline and the receiver pipeline based on a mapping between the sender pipeline and the receiver pipeline stored in the sender realm without identifying the sender pipeline outside the sender realm.

As shown in FIG. 5A, a system monitors for trigger events for sending data across a cross-realm communication channel between a sender pipeline in a sender realm and a receiver pipeline in a receive realm (Operation 502). In one example, a trigger event for sending data across the cross-realm communication channel includes the system determining that data has been added to a sender data storage unit. A cross-realm service in the sender realm may monitor the sender data storage unit for data that is added to the sender data storage unit. Additionally, or alternatively, the system may provide a notification to the cross-realm service when data is added to the sender data storage unit. In one example, when the system determines that data has been added to the sender data storage unit, the system generates a trigger event corresponding to the data added to the sender data storage unit. The trigger event identifies the data and the sender data storage unit where the data is located. In one example, after generating the trigger event, the system adds the trigger event to an event queue.

The system determines whether a trigger event been detected (Operation 504). The system may monitor the event queue for trigger events. Additionally, or alternatively, the system may provide a notification to the cross-realm service when a trigger event is added to the event queue. The event queue may include multiple trigger events. The cross-realm service may process the trigger events in a defined order such as in a sequential order. When the system determines that a trigger event has not been detected, the system continues monitoring the event queue or awaits a notification.

When the system determines that a trigger event is detected, the system identifies a mapping between the sender pipeline and the receiver pipeline (Operation 506). The system may determine a sender pipeline identifier that identifies a sender pipeline corresponding to the sender data storage unit based on metadata associated with the sender data storage unit. The system may identify the mapping between the sender pipeline and the receiver pipeline based on the sender pipeline identifier determined from the metadata. The system may access a set of pipeline mappings. The system may identify the mapping between the sender pipeline and the receiver pipeline in the set of pipeline mappings based on the sender pipeline identifier. The set of pipeline mappings may include multiple mappings between different sender pipelines and receiver pipelines. The mappings respectively include a sender pipeline field mapped to a receiver pipeline field. The sender pipeline field includes a first string of characters identifying the sender pipeline. The receiver pipeline field includes a second string of characters identifying the receiver pipeline.

The system determines the receiver pipeline that is mapped to the sender pipeline based on the mapping between the sender pipeline and the receiver pipeline (Operation 508). The system may identify a mapping that includes a sender pipeline identifier that matches the sender pipeline identifier in the metadata associated with the sender data storage unit. The system may identify a mapping with a sender pipeline field that includes a first string of characters corresponding to the sender pipeline identifier in the metadata. The system may determine a second string of characters in the receiver pipeline field mapped to the sender pipeline field. The system may determine a receiver pipeline identifier that corresponds to the second string of characters in the receiver pipeline field.

The system generates a message that includes the data from the sender data storage unit and a receiver pipeline identifier of the receiver pipeline (Operation 510). In one example, the data in the sender data storage unit includes a file. The system obtains the file from the sender data storage unit. The system generates a manifest that includes the receiver pipeline identifier of the receiver pipeline. The receiver pipeline identifier is utilized to identify the cross-realm communication channel for transferring the message to the receiver realm.

The system secures the message utilizing a realm-specific private key associated with the sender realm (Operation 512). In one example, the system utilizes the realm-specific private key to generate a security feature. The security feature may include a digital signature over at least a portion of the message. In one example, the system digitally signs the manifest. Additionally, or alternatively, the security feature may include encrypting the data and/or the message for transmission over the cross-realm communication channel. The system may utilize the realm-specific private key to encrypt the data and/or the message.

After securing the message utilizing the pipeline-specific private key, the system transmits the message to the receiver realm (Operation 514). The cross-realm service may initiate transmission of the message by directing the message to a sender gateway. The sender gateway may be located in a service tenancy of the sender realm. The sender gateway may transmit the message to a receiver gateway in the receiver realm. When the receiver gateway receives the message, the receiver gateway may store the message in an intermediate data repository in the receiver realm.

As shown in FIG. 5B, a system monitors the intermediate data repository for messages transmitted across the cross-realm communication channel (Operation 552). A cross-realm service in the receiver realm may monitor the intermediate data repository for messages added to the intermediate data repository. Additionally, or alternatively, the system may provide a notification to the cross-realm service when messages are added to the intermediate data repository. In one example, when a message is added to the intermediate data repository, the system adds a message event to an event queue. The system may monitor the event queue for message events. Additionally, or alternatively, the system may provide a notification to the cross-realm service when an message event is added to the event queue. The event queue may include multiple message events. The cross-realm service may process the message events in a defined order such as in a sequential order. When the system determines that a message event has not been detected, the system continues monitoring the event queue or awaits a notification.

The system determines whether a message has been received (Operation 554). When the system determines that a message has not been received, the system awaits receipt of a message. When the system determines that a message has been received, the system accesses the message and processes the message.

The system accesses a realm-specific public key based on a receiver pipeline identifier in the message (Operation 556). The system utilizes the realm-specific public key to access data, such as a file, in the message. The system may parse the message to determine the receiver pipeline identifier. The message may include a manifest. The receiver pipeline identifier may be included in the manifest. The system may determine the receiver pipeline identifier based on the manifest. The system may locate the realm-specific public key based on a mapping of the receiver pipeline identifier to the realm-specific public key. In one example, the receiver pipeline identifier includes a first string of characters representing a first subset of a whole identifier of the receiver pipeline. The receiver pipeline identifier does not include a second string of characters representing a second subset of the whole identifier of the receiver pipeline. The realm-specific public key may be stored in association with the whole pipeline identifier. The system may identify the realm-specific public key in a data repository based on the receiver pipeline identifier. The system may determine that the whole identifier includes the first string of characters of the receiver pipeline identifier.

The system verifies a security feature of the message utilizing the realm-specific public key (Operation 558).

The system may access data, such as a file, in the message in response to successfully verifying the security feature of the message. In one example, the security feature includes a digital signature that was generated utilizing the realm-specific private key. The system may validate the digital signature utilizing the realm-specific public key. Additionally, or alternatively, the security feature may include an encryption of the message or data contained within the message. The system may decrypt the encryption utilizing the realm-specific public key.

The system determines whether the security feature has been successfully verified (Operation 560). If the security feature is not successfully verified, the system rejects the message (Operation 562). To reject the message, the system may delete the message from the intermediate data repository. Additionally, or alternatively, the system may refrain from transferring the message to a receiver data storage unit associated with the receiver pipeline.

As shown in FIG. 5C, the system determines the receiver pipeline based on the message (Operation 564). The system accesses the manifest and determines the receiver pipeline identifier included in the manifest. After determining the receiver pipeline, the system stores the data, such as the file, from the message in a receiver data storage unit associated with the receiver pipeline (Operation 566). The receiver data storage unit may be designated for receiving files transmitted to the receiver pipeline over the communication channel. The system may identify the receiver data storage unit based on metadata associated with the receiver pipeline. The receiver data storage unit may be mapped to the receiver pipeline in the metadata. The system transmits the data, such as the file, to the receiver data storage unit.

After transmitting the data to the receiver data storage unit, the system marks the data as being available for access from the receiver data storage unit (Operation 568). The system may mark the data as available for access by updating metadata associated with the receiver data storage unit. Additionally, or alternatively, the system may generate a notification that the data is available for access from the receiver data storage unit. The system may render a display on a GUI indicating that the data is available for access from the receiver data storage unit.

### 4. Example Embodiments

Detailed examples are described below for purposes of clarity. Components and/or operations described below should be understood as one specific example that may not be applicable to certain embodiments. Accordingly, components and/or operations described below should not be construed as limiting the scope of any of the claims.

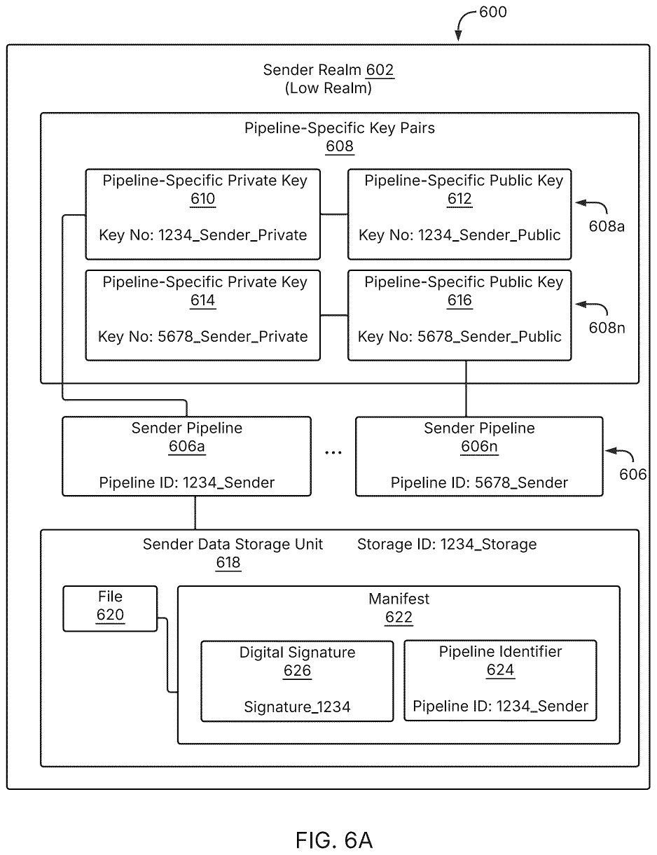

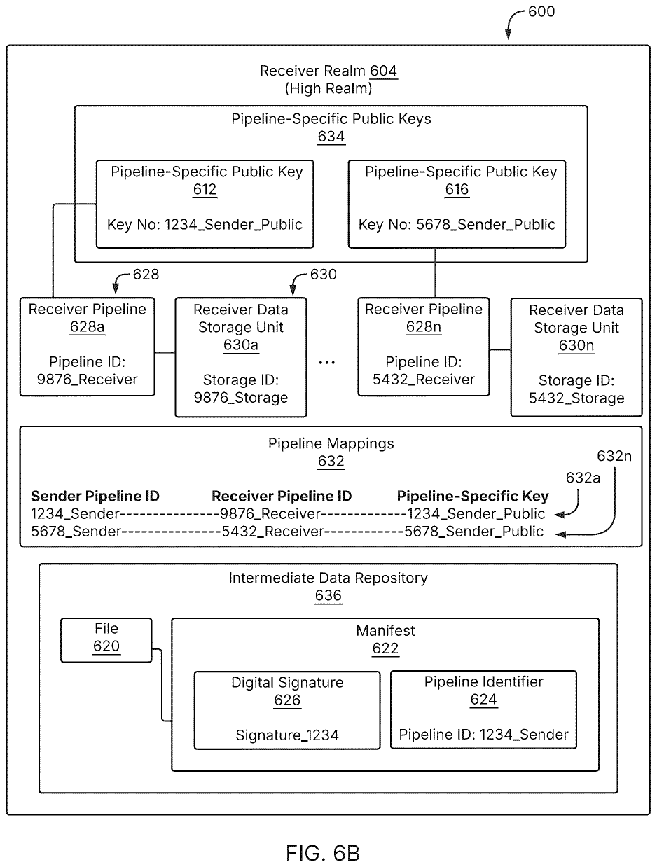

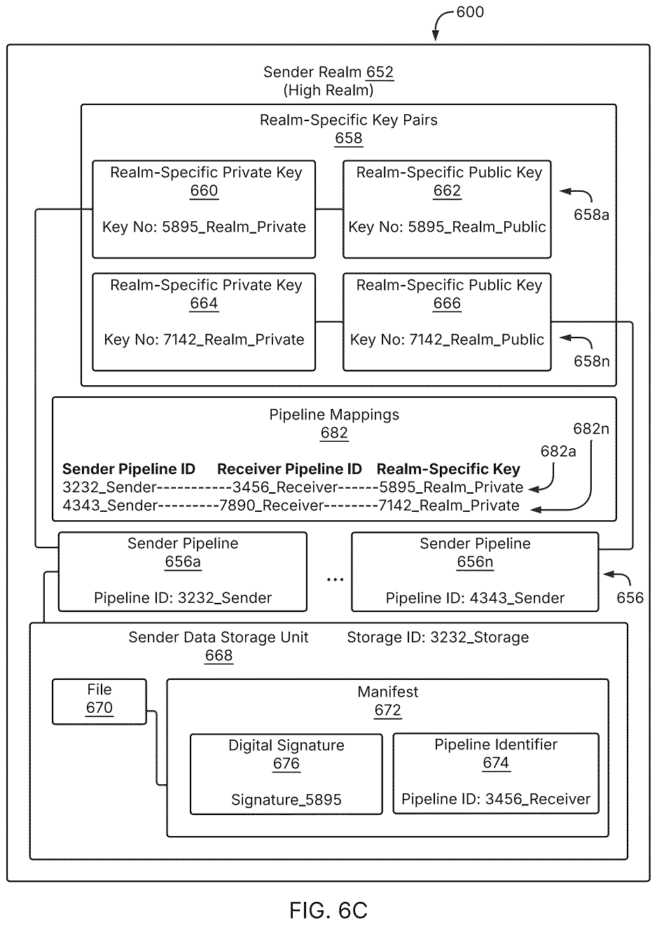

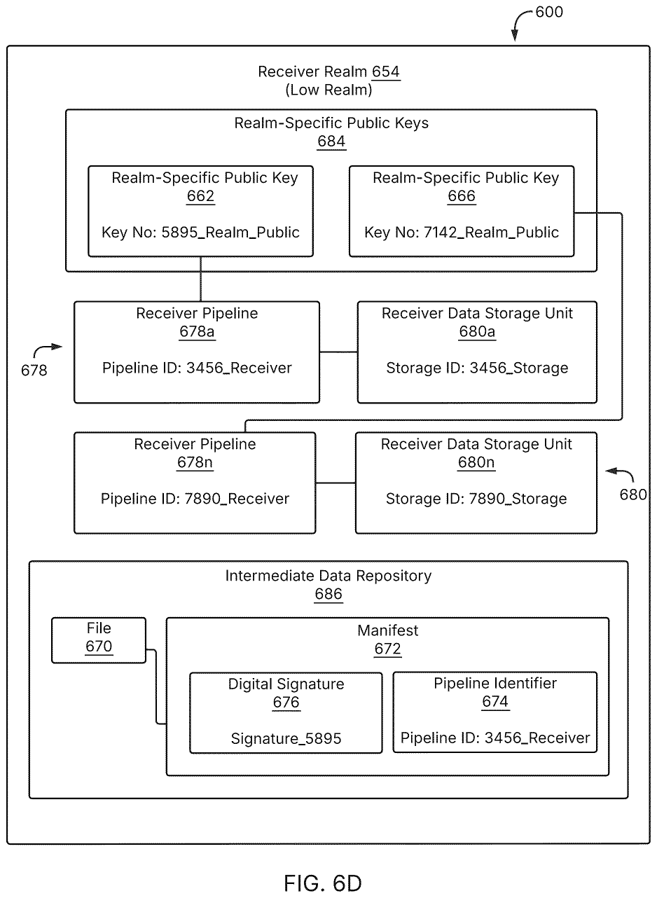

Referring to FIGS. 6A-6D, an example system 600 for executing cross-realm communications between a sender realm and a receiver realm is further described. As described with reference to FIGS. 6A and 6B, the system 600 may include a sender realm 602 (FIG. 6A) that is a low real and a receiver realm 604 (FIG. 6B) that is a high realm. The sender realm 602 may transfer data to the receiver realm 604 over one or more cross-realm communication channels. Additionally, or alternatively, as described with reference to FIGS. 6C and 6D, the system 600 may include a sender realm 652 (FIG. 6C) that is a high real and a receiver realm 654 (FIG. 6D) that is a low realm. The sender realm 652 may transfer data to the receiver realm 654 over one or more cross-realm communication channels.

In one example, the sender realm 602 and the receiver realm 654 are the same realm. Additionally, or alternatively, the sender realm 652 and the receiver realm 604 may be the same realm. The sender realm 602 and the receiver realm 654 can be the same realm, and/or the sender realm 652 and the receiver realm 604 can be the same realm. In one example, a low realm may transmit data to a high realm over a first cross-realm communication channel, and the high realm may transmit data to the low realm over a second cross-realm communication channel.

In one example, the sender realm 602 and the sender realm 652 are the same realm. The sender realm 602 and the sender realm 652 can be the same realm when a particular sender realm is a low realm with respect to a first receiver realm (e.g., receiver realm 604) and a high realm with respect to a second receiver realm (e.g., receiver realm 654). The receiver realm 604 and the receiver realm 654 can be different realms. Additionally, or alternatively, a particular receiver realm can be a high realm (e.g. receiver realm 604) with respect to a first cross-realm communication channel and a low realm (e.g. receiver realm 654) with respect to a second cross-realm communication channel.

In one example, the receiver realm 604 and the receiver realm 654 are the same realm. The receiver realm 604 and the receiver realm 654 can be the same realm when a particular receiver realm is a high realm with respect to a first sender realm (e.g., sender realm 602) and a low realm with respect to a second sender realm (e.g., sender realm 652). The sender realm 602 and the sender realm 652 can be different realms. Additionally, or alternatively, a particular sender realm can be a low realm (e.g. sender realm 602) with respect to a first cross-realm communication channel and a high realm (e.g. sender realm 652) with respect to a second cross-realm communication channel.

### A. Cross-Realm Communications from Low Sender Realms to High Receiver Realms

As shown in FIG. 6A, sender realm 602 is a low realm. Sender realm 602 includes multiple sender pipelines 606, such as sender pipeline 606a and sender pipeline 606n. Sender pipeline 606a represents an upstream endpoint for a first cross realm communication channel. Sender pipeline 606n represents an upstream endpoint for a second cross realm communication channel. In one example, sender realm 602 does not include information pertaining to receiver pipelines in receiver realms corresponding to the sender pipelines 606. In one example, the receiver pipelines corresponding to the sender pipelines are deployed in receiver realm 604 (FIG. 6B). Sender realm 602 includes a set of pipeline-specific key pairs 608, such as pipeline-specific key pair 608a and pipeline-specific key pair 608n. Pipeline-specific key pair 608a includes pipeline-specific private key 610 and pipeline-specific public key 612. Pipeline-specific key pair 608n includes pipeline-specific private key 614 and pipeline-specific public key 616. Pipeline-specific key pair 608a is mapped to sender pipeline 606a. Pipeline-specific private key 610 of pipeline-specific key pair 608a is utilized to secure data transferred over a cross-realm communication channel that includes sender pipeline 606a as an upstream endpoint. Pipeline-specific key pair 608n is mapped to sender pipeline 606n. Pipeline-specific private key 614 of pipeline-specific key pair 608n is utilized to secure data transferred over a cross-realm communication channel that includes sender pipeline 606n as an upstream endpoint.

Sender pipeline 606a is identifiable based on pipeline-specific private key 610. As shown in FIG. 6A, the pipeline identifier of sender pipeline 606a is 1234_Sender, and pipeline-specific private key 610 is represented by key number 1234_Sender_Private. A portion of the characters of Key number 1234_Sender_Private of pipeline-specific private key 610 includes the pipeline identifier 1234_Sender of sender pipeline 606a. Sender pipeline 606n is identifiable based on pipeline-specific private key 614. As shown in FIG. 6A, the pipeline identifier of sender pipeline 606n is 5678_Sender, and pipeline-specific private key 614 is represented by key number 5678_Sender_Private. A portion of the characters of Key number 5678_Sender_Private of pipeline-specific private key 610 includes the pipeline identifier 55678_Sender of sender pipeline 606a.

Sender realm 602 includes sender data storage unit 618. Sender data storage unit 618 is mapped to sender pipeline 606a. Data in sender data storage unit 618 is transferred from the sender realm 602 over a cross-realm communication channel between sender pipeline 606a and a receiver realm such as receiver realm 604 (FIG. 6B). Sender pipeline 606n is mapped to a different sender data storage unit (not shown). Sender pipeline 606n is utilized for a different cross-realm communication channel. The data in sender data storage unit 618 incudes a file 620 and a manifest 622. The manifest 622 includes a pipeline identifier 624 and a digital signature 626. The pipeline identifier 624 identifies sender pipeline 606a. As shown in FIG. 6A, sender pipeline 606a is identified by pipeline identification 1234_Sender. Pipeline identifier 624 in the manifest 622 includes the pipeline identifier 1234_Sender corresponding to sender pipeline 606a. The digital signature 626 is generated by pipeline-specific private key 610 of pipeline-specific key pair 608a. As shown in FIG. 6A, digital signature 626 includes a signature represented as Signature_1234 corresponding to key number 1234_Sender_Private of pipeline-specific private key 610. A message that includes file 620 and manifest 622 is transferred across the cross-realm communication channel between sender pipeline 606a and a receiver pipeline in a receiver realm such as receiver realm 604.

Referring to FIG. 6B, receiver realm 604 is a high realm. In one example, the message that includes file 620 and manifest 622 is transferred to the receiver realm 604 across the cross-realm communication channel from sender pipeline 606a (FIG. 6A). As shown in FIG. 6B, receiver realm 604 includes multiple receiver pipelines 628 mapped to multiple receiver data storage units 630, respectively. As shown in FIG. 6B, receiver pipeline 628a is mapped to receiver data storage unit 630a, and receiver pipeline 628n is mapped to receiver data storage unit 630n. Receiver pipeline 628a represents a downstream endpoint for a first cross realm communication channel. In one example, the upstream endpoint of the first cross realm communication channel is sender pipeline 606a (FIG. 6A), and the downstream endpoint of the first cross realm communication channel is receiver pipeline 628a. Data transmitted over the first cross-realm communication channel between sender pipeline 606a (FIG. 6A) and receiver pipeline 628a is transferred to receiver data storage unit 630a. Receiver pipeline 628n represents a downstream endpoint for a second cross realm communication channel.

Receiver realm 604 includes a set of pipeline mappings 632. The set of pipeline mappings 632 include mapping 632a and mapping 632n. Mapping 632a maps sender pipeline 606a (FIG. 6A) to receiver pipeline 628a based on pipeline identifiers corresponding to sender pipeline 606a and receiver pipeline 628a, respectively. As shown in FIG. 6B, mapping 632a includes sender pipeline identifier 1234_Sender corresponding to the sender pipeline identifier of sender pipeline 606a (FIG. 6A). Sender pipeline identifier 1234_Sender of mapping 632a is mapped to receiver pipeline identifier 9876_Receiver corresponding to the receiver pipeline identifier of receiver pipeline 628a. Mapping 632n maps sender pipeline 606n (FIG. 6A) to receiver pipeline 628n based on pipeline identifiers corresponding to sender pipeline 606n and receiver pipeline 628n, respectively. As shown in FIG. 6B, mapping 632n includes sender pipeline identifier 5678_Sender corresponding to the sender pipeline identifier of sender pipeline 606n (FIG. 6A). Sender pipeline identifier 5678_Sender of mapping 632n is mapped to receiver pipeline identifier 5432_Receiver corresponding to the receiver pipeline identifier of receiver pipeline 628n.

Receiver realm 604 includes a set of pipeline-specific public keys 634, such as pipeline-specific public key 612 and pipeline-specific public key 616. Pipeline-specific public key 612 corresponds to pipeline-specific key pair 608a (FIG. 6A). Pipeline-specific public key 612 was transferred to receiver realm 604 from sender realm 602, for example, when initializing the cross-realm communication channel between sender pipeline 606a and receiver pipeline 628a. Pipeline-specific public key 616 was transferred to receiver realm 604 from sender realm 602, for example, when initializing the cross-realm communication channel between sender pipeline 606n and receiver pipeline 628n. Pipeline-specific public key 612 is mapped to receiver pipeline 628a. Pipeline-specific public key 612 is utilized to access data transferred over the cross-realm communication channel between sender pipeline 606a and receiver pipeline 628a that has been secured by pipeline-specific private key 610 (FIG. 6A). Pipeline-specific public key 616 is mapped to receiver pipeline 628n. Pipeline-specific public key 616 is utilized to access data transferred over the cross-realm communication channel between sender pipeline 606n and receiver pipeline 628n that has been secured by pipeline-specific private key 614 (FIG. 6A).

Receiver realm 604 includes an intermediate data repository 636. Data received from by the receiver realm 604 over cross-realm communication channels is stored in the intermediate data repository 636 prior to being transferred to a receiver data storage unit 630. As shown in FIG. 6B, intermediate data repository 636 includes file 620 and manifest 622 transferred from sender realm 602. The system verifies digital signature 626 using pipeline-specific public key 612. The system identifies pipeline-specific public key 612 based on the pipeline identifier 624 in the manifest 622. The system matches the pipeline identification number 1234_Sender from pipeline identifier 624 to the sender pipeline identifier 1234_Sender in mapping 632a. The system identifies pipeline-specific public key 612 based on the mapping between key number 1234_Sender_Public and sender pipeline identifier 1234_Sender in mapping 632a. After verifying the digital signature 626, the system transfers file 620 to receiver data storage unit 630a based on the mapping between receiver pipeline 628a and receiver data storage unit 630a.

### B. Cross-Realm Communications from High Sender Realms to Low Receiver Realms

As shown in FIG. 6C, sender realm 652 is a low realm. Sender realm 652 includes multiple sender pipelines 656, such as sender pipeline 656a and sender pipeline 656n. Sender pipeline 656a represents an upstream endpoint for a first cross realm communication channel. Sender pipeline 656n represents an upstream endpoint for a second cross realm communication channel. Sender realm 652 includes a set of realm-specific key pairs 658, such as realm-specific key pair 658a and realm-specific key pair 658n. Realm-specific key pair 658a includes realm-specific private key 660 and realm-specific public key 662. Realm-specific key pair 658n includes realm-specific private key 664 and realm-specific public key 666. Realm-specific key pair 658a is mapped to sender pipeline 656a. Realm-specific private key 660 of realm-specific key pair 658a is utilized to secure data transferred over a cross-realm communication channel that includes sender pipeline 656a as an upstream endpoint. Realm-specific key pair 658n is mapped to sender pipeline 656n. Realm-specific private key 664 of realm-specific key pair 658n is utilized to secure data transferred over a cross-realm communication channel that includes sender pipeline 656n as an upstream endpoint.

Receiver realm 654 includes a set of pipeline mappings 682. The set of pipeline mappings 682 include mapping 682a and mapping 682n. Mapping 682a maps sender pipeline 656a to receiver pipeline 678a (FIG. 6D) based on pipeline identifiers corresponding to sender pipeline 656a and receiver pipeline 678a, respectively. As shown in FIG. 6C, mapping 682a includes sender pipeline identifier 3232_Sender corresponding to the sender pipeline identifier of sender pipeline 656a. Sender pipeline identifier 3232_Sender of mapping 682a is mapped to receiver pipeline identifier 3456_Receiver corresponding to the receiver pipeline identifier of receiver pipeline 678a (FIG. 6D). Mapping 682n maps sender pipeline 656n to receiver pipeline 678n based on pipeline identifiers corresponding to sender pipeline 656n and receiver pipeline 678n (FIG. 6D), respectively. As shown in FIG. 6C, mapping 682n includes sender pipeline identifier 4343_Sender corresponding to the sender pipeline identifier of sender pipeline 656n. Sender pipeline identifier 4343_Sender of mapping 682n is mapped to receiver pipeline identifier 7890_Receiver corresponding to the receiver pipeline identifier of receiver pipeline 678n (FIG. 6D).

Sender realm 652 includes sender data storage unit 668. Sender data storage unit 668 is mapped to sender pipeline 656a. Data in sender data storage unit 668 is transferred from the sender realm 652 over a cross-realm communication channel between sender pipeline 656a and a receiver realm such as receiver realm 654 (FIG. 6D). Sender pipeline 656n is mapped to a different sender data storage unit (not shown). Sender pipeline 656n is utilized for a different cross-realm communication channel. The data in sender data storage unit 668 incudes a file 670 and a manifest 672. The manifest 672 includes a pipeline identifier 674 and a digital signature 676. The pipeline identifier 674 identifies a receiver pipeline corresponding to receiver pipeline 3456_Receiver. As shown in FIG. 6D, receiver pipeline 678a is identified by pipeline identification 3456_Receiver. Pipeline identifier 674 in the manifest 672 includes the pipeline identifier 3456_Receiver corresponding to receiver pipeline 678a (FIG. 6D). The digital signature 676 is generated by realm-specific private key 660 of realm-specific key pair 658a. As shown in FIG. 6C, digital signature 676 includes a signature represented as Signature_5895 corresponding to key number 5895_Realm_Private of realm-specific private key 660. A message that includes file 670 and manifest 672 is transferred across the cross-realm communication channel between sender pipeline 656a and a receiver pipeline in a receiver realm, such as receiver realm 654.

Referring to FIG. 6D, receiver realm 654 is a low realm. In one example, the message that includes file 670 and manifest 672 is transferred to the receiver realm 654 across the cross-realm communication channel from sender pipeline 656a (FIG. 6C). As shown in FIG. 6D, receiver realm 654 includes multiple receiver pipelines 678 mapped to multiple receiver data storage units 680, respectively. In one example, receiver realm 654 does not include information pertaining to sender pipelines in sender realms corresponding to the receiver pipelines 678. In one example, the sender pipelines corresponding to the receiver pipelines are deployed in sender realm 652 (FIG. 6C).

As shown in FIG. 6D, receiver pipeline 678a is mapped to receiver data storage unit 680a, and receiver pipeline 678n is mapped to receiver data storage unit 680n. Receiver pipeline 678a represents a downstream endpoint for a first cross realm communication channel. In one example, the upstream endpoint of the first cross realm communication channel is sender pipeline 656a (FIG. 6C), and the downstream endpoint of the first cross realm communication channel is receiver pipeline 678a. Data transmitted over the first cross-realm communication channel between sender pipeline 656a (FIG. 6C) and receiver pipeline 678a is transferred to receiver data storage unit 680a. Receiver pipeline 678n represents a downstream endpoint for a second cross realm communication channel.

Receiver realm 654 includes a set of realm-specific public keys 684, such as realm-specific public key 662 and realm-specific public key 666. Realm-specific public key 662 corresponds to realm-specific key pair 658a (FIG. 6C). In one example, realm-specific public key 662 was made available to receiver realm 654 when provisioning receiver realm 654. Additionally, or alternatively, the system may have transferred realm-specific public key 662 from sender realm 652 to receiver realm 654, for example, when initializing the cross-realm communication channel between sender pipeline 656a and receiver pipeline 678a. In one example, realm-specific public key 666 was made available to receiver realm 654 when provisioning receiver realm 654. Additionally, or alternatively, the system may have transferred realm-specific public key 666 from sender realm 652 to receiver realm 654, for example, when initializing the cross-realm communication channel between sender pipeline 656n and receiver pipeline 678n. Realm-specific public key 662 is mapped to receiver pipeline 678a. Realm-specific public key 662 is utilized to access data transferred over the cross-realm communication channel between sender pipeline 656a and receiver pipeline 678a that has been secured by realm-specific private key 660 (FIG. 6C). Realm-specific public key 666 is mapped to receiver pipeline 678n. Realm-specific public key 666 is utilized to access data transferred over the cross-realm communication channel between sender pipeline 656n and receiver pipeline 678n that has been secured by realm-specific private key 664 (FIG. 6C).

Receiver realm 654 includes an intermediate data repository 686. Data received from by the receiver realm 654 over cross-realm communication channels is stored in the intermediate data repository 686 prior to being transferred to a receiver data storage unit 680. As shown in FIG. 6D, intermediate data repository 686 includes file 670 and manifest 672 transferred from sender realm 652. The system verifies digital signature 676 using realm-specific public key 662. The system identifies realm-specific public key 662 based on the pipeline identifier 674 in the manifest 672. The system matches the pipeline identification number 3456_Receiver from pipeline identifier 674 to the receiver pipeline identifier 3456_Receiver of receiver pipeline 678a mapped to realm-specific public key 662. After verifying the digital signature 676, the system transfers file 670 to receiver data storage unit 680a based on the mapping between receiver pipeline 678a and receiver data storage unit 680a.

### 5. Practical Applications, Advantages, and Improvements

Embodiments provide several practical applications, advantages, and improvements. The cross-realm communication channels described herein are utilized to transfer data between realms that are logically isolated from one another and that operates on physical components of a cloud infrastructure that are physically isolated from one another. The cross-realm communication channels accommodate different restriction levels of high realms and low realms. The cross-realm communication channels provide improved security by mapping sender and receiver pipelines in the high ream and refraining from sharing mapping information to the low realm. Additionally, the cross-realm communication channels accommodate restrictions on data egress from a high realm by refraining from sharing pipeline information from the high realm to the low realm.

Data security is improved by utilizing pipeline-specific keys to secure and access data. For example, if a pipeline-specific key becomes compromised, other cross-realm communication channels that utilize different pipeline-specific keys may be unaffected. Additionally, by utilizing pipeline-specific public keys, the receiver cross-realm service can utilize the pipeline-specific public key to verify that the data secured by the pipeline-specific private key originated from the sender pipeline because the sender pipeline service corresponding to the sender pipeline has exclusive access to utilize the pipeline-specific private key.

When transmitting data over a cross-realm communication channel from a high realm to a low realm, security is improved because the sender pipeline information is not shared with the receiver realm. A realm-specific key pair is utilized to secure an access the data transmitted from the high realm to the low realm. The receiver cross-realm service in the receiver realm can utilize the realm-specific public key to verify that the data secured by the realm-specific private key originated from the sender realm because only the sender realm has access to the realm-specific private key.

### 6. Cloud Computing Technology

As noted above, infrastructure as a service (IaaS) is one particular type of cloud computing. For IaaS, the infrastructure (CSPI) provided by a CSP can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). CSPI thus provides infrastructure and a set of complementary cloud services that enable customers to build and run a wide range of applications and services in a highly available hosted distributed environment. The customer does not manage or control the underlying physical resources provided by CSPI but has control over operating systems, storage, and deployed applications; and possibly limited control of select networking components (e.g., firewalls).

In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance. When a customer subscribes to or registers for an IaaS service provided by a CSP, a tenancy, or account, is created for the customer. A tenancy is a secure and isolated partition within the CSPI where the customer can create, organize, and administer their cloud resources.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) of the CSPI serves a single customer or tenant. In a multi-tenancy architecture, a software or a hardware component of the CSPI serves multiple customers or tenants. Thus, in a multi-tenancy architecture, CSPI resources are shared between multiple customers or tenants. In a multi-tenancy situation, precautions are taken, and safeguards put in place within CSPI to ensure that each tenant's data is isolated and remains invisible to other tenants.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
cid1.<RESOURCE TYPE>.<REALM>.[REGION][.FUTURE USE].<UNIQUE ID>
where,
cid1: The literal string indicating the version of the CID;
resource type: The type of resource (for example, instance, volume, VCN, subnet, user, group, and so on);
realm: The realm the resource is in. Example values are “c1” for the commercial realm, “c2” for the Government Cloud realm, or “c3” for the Federal Government Cloud realm, etc. Each realm may have its own domain name;
region: The region the resource is in. If the region is not applicable to the resource, this part might be blank;
future use: Reserved for future use.
unique ID: The unique portion of the ID. The format may vary depending on the type of resource or service.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed are required to first be set up. In some instances, the provisioning can be done manually, a provisioning tool may be utilized to provision the resources, and/or deployment tools may be utilized to deploy the code once the infrastructure is provisioned.

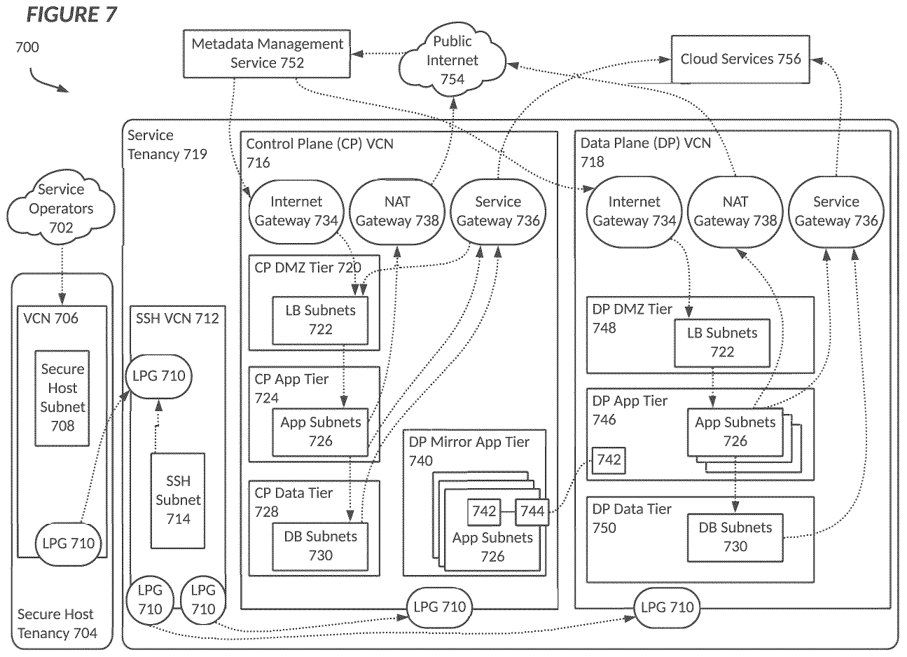

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, that may be portable handheld devices (e.g., an iPhone®, cellular telephone, an iPad®, computing tablet, a personal digital assistant (PDA)) or wearable devices (e.g., a Google Glass® head mounted display), executing software, such as Microsoft Windows Mobile®, and/or a variety of mobile operating systems, such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, by way of example, including personal computers and/or laptop computers that are executing various versions of Microsoft Windows®, Apple Macintosh®, and/or Linux operating systems. The client computing devices can be workstation computers executing any of a variety of commercially available UNIX® or UNIX-like operating systems that include, for example, GNU/Linux operating systems and Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 implemented in the SSH VCN 712. The SSH VCN 712 can include an SSH subnet 714, and the SSH VCN 712 can be communicatively coupled to a control plane VCN 716 via the LPG 710 implemented in the control plane VCN 716. Also, the SSH VCN 712 can be communicatively coupled to a data plane VCN 718 via an LPG 710. The control plane VCN 716 and the data plane VCN 718 can be implemented in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 in the control plane DMZ tier 720 can be communicatively coupled to the app subnet(s) 726 in the control plane app tier 724 and an Internet gateway 734 that can be implemented in the control plane VCN 716. The app subnet(s) 726 can be communicatively coupled to the DB subnet(s) 730 implemented in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 implemented in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be implemented in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively couple to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way; the service gateway 736 can make API calls to cloud services 756, and cloud services 756 can send requested data to the service gateway 736. However, cloud services 756 may not initiate API calls to the service gateway 736.

In some examples, the secure host tenancy 704 can be directly connected to the service tenancy 719. The service tenancy 719 may otherwise be isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision resources. Resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be implemented in the data plane mirror app tier 740 and the data plane app tier 746.

In some examples, users or customers, of the system, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 implemented in the control plane DMZ tier 720. The LB subnet(s) 722 may determine that the request is valid, and in response, the LB subnet(s) 722 can transmit the request to app subnet(s) 726 implemented in the control plane app tier 724. If the request is validated and requires a call to public Internet 754, the call to public Internet 754 may be transmitted to the NAT gateway 738 that can make the call to public Internet 754. Metadata to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to a configuration may need to be applied to the resources implemented in the data plane VCN 718. Via a VNIC 742, the control plane VCN 716 can directly communicate with, and can thereby execute the changes, updates, or other suitable modifications to configuration to, resources implemented in the data plane VCN 718.

In some embodiments, the control plane VCN 716 and the data plane VCN 718 can be implemented in the service tenancy 719. In this case, the user, or the customer, of the system may not own or operate either the control plane VCN 716 or the data plane VCN 718. Instead, the IaaS provider may own or operate the control plane VCN 716 and the data plane VCN 718. The control plane VCN 716 and the data plane VCN 718 may be implemented in the service tenancy 719. This embodiment can enable isolation of networks that may prevent users or customers from interacting with other users', or other customers', resources. Also, this embodiment may allow users, or customers, of the system to store databases privately without needing to rely on public Internet 754, that may not have a sufficient level of threat protection, for storage.

In other embodiments, the LB subnet(s) 722 implemented in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may need this embodiment since database(s) that the customers use may be controlled by the IaaS provider and may be stored on the service tenancy 719. The service tenancy 719 may be isolated from public Internet 754.

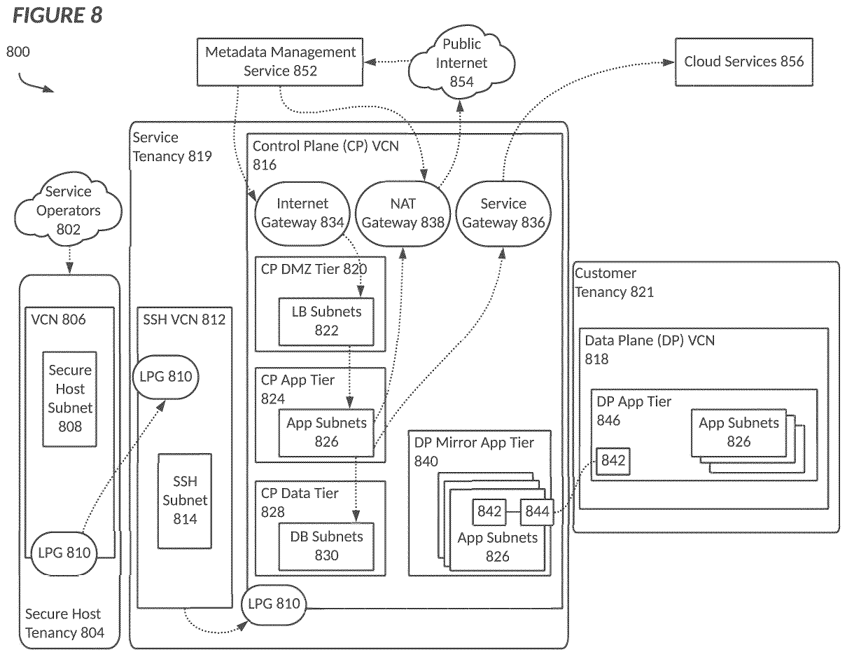

FIG. 8 is a block diagram 800 illustrating another example pattern of an IaaS architecture, according to at least one embodiment. Service operators 802 (e.g., service operators 702 of FIG. 7) can be communicatively coupled to a secure host tenancy 804 (e.g., the secure host tenancy 704 of FIG. 7) that can include a virtual cloud network (VCN) 806 (e.g., the VCN 706 of FIG. 7) and a secure host subnet 808 (e.g., the secure host subnet 708 of FIG. 7). The VCN 806 can include a local peering gateway (LPG) 810 (e.g., the LPG 710 of FIG. 7) that can be communicatively coupled to a secure shell (SSH) VCN 812 (e.g., the SSH VCN 712 of FIG. 7) via an LPG 810 implemented in the SSH VCN 812. The SSH VCN 812 can include an SSH subnet 814 (e.g., the SSH subnet 714 of FIG. 7), and the SSH VCN 812 can be communicatively coupled to a control plane VCN 816 (e.g., the control plane VCN 716 of FIG. 7) via an LPG 810 implemented in the control plane VCN 816. The control plane VCN 816 can be implemented in a service tenancy 819 (e.g., the service tenancy 719 of FIG. 7), and the data plane VCN 818 (e.g., the data plane VCN 718 of FIG. 7) can be implemented in a customer tenancy 821 that may be owned or operated by users, or customers, of the system.

The control plane VCN 816 can include a control plane DMZ tier 820 (e.g., the control plane DMZ tier 720 of FIG. 7) that can include LB subnet(s) 822 (e.g., LB subnet(s) 722 of FIG. 7), a control plane app tier 824 (e.g., the control plane app tier 724 of FIG. 7) that can include app subnet(s) 826 (e.g., app subnet(s) 726 of FIG. 7), and a control plane data tier 828 (e.g., the control plane data tier 728 of FIG. 7) that can include database (DB) subnet(s) 830 (e.g., similar to DB subnet(s) 730 of FIG. 7). The LB subnet(s) 822 implemented in the control plane DMZ tier 820 can be communicatively coupled to the app subnet(s) 826 implemented in the control plane app tier 824 and an Internet gateway 834 (e.g., the Internet gateway 734 of FIG. 7) that can be implemented in the control plane VCN 816. The app subnet(s) 826 can be communicatively coupled to the DB subnet(s) 830 implemented in the control plane data tier 828 and a service gateway 836 (e.g., the service gateway 736 of FIG. 7) and a network address translation (NAT) gateway 838 (e.g., the NAT gateway 738 of FIG. 7). The control plane VCN 816 can include the service gateway 836 and the NAT gateway 838.

The control plane VCN 816 can include a data plane mirror app tier 840 (e.g., the data plane mirror app tier 740 of FIG. 7) that can include app subnet(s) 826. The app subnet(s) 826 implemented in the data plane mirror app tier 840 can include a virtual network interface controller (VNIC) 842 (e.g., the VNIC of 742) that can execute a compute instance 844 (e.g., similar to the compute instance 744 of FIG. 7). The compute instance 844 can facilitate communication between the app subnet(s) 826 of the data plane mirror app tier 840 and the app subnet(s) 826 that can be implemented in a data plane app tier 846 (e.g., the data plane app tier 746 of FIG. 7). The compute instance 844 can facilitate this communication via the VNIC 842 implemented in the data plane mirror app tier 840 and the VNIC 842 implemented in the data plane app tier 846.

The Internet gateway 834 implemented in the control plane VCN 816 can be communicatively coupled to a metadata management service 852 (e.g., the metadata management service 752 of FIG. 7) that can be communicatively coupled to public Internet 854 (e.g., public Internet 754 of FIG. 7). Public Internet 854 can be communicatively coupled to the NAT gateway 838 implemented in the control plane VCN 816. The service gateway 836 implemented in the control plane VCN 816 can be communicatively couple to cloud services 856 (e.g., cloud services 756 of FIG. 7).

In some examples, the data plane VCN 818 can be implemented in the customer tenancy 821. In this case, the IaaS provider may provide the control plane VCN 816 for a customer, and the IaaS provider may, for a customer, set up a unique, compute instance 844 that is implemented in the service tenancy 819. A compute instance 844 may allow communication between the control plane VCN 816 implemented in the service tenancy 819 and the data plane VCN 818 that is implemented in the customer tenancy 821. The compute instance 844 may allow resources provisioned in the control plane VCN 816 that is implemented in the service tenancy 819 to be deployed or otherwise used in the data plane VCN 818 that is implemented in the customer tenancy 821.

In other examples, the customer of the IaaS provider may have databases that are implemented in the customer tenancy 821. In this example, the control plane VCN 816 can include the data plane mirror app tier 840 that can include app subnet(s) 826. The data plane mirror app tier 840 can be implemented in the control plane VCN 816, but the data plane mirror app tier 840 may not be implemented in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity implemented in the control plane VCN 816. The customer may need to deploy or otherwise use resources in the data plane VCN 818 that are provisioned in the control plane VCN 816, and the data plane mirror app tier 840 can facilitate the deployment or other usage of resources of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, implemented in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be active or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 1” may be located in Region 1 and in “Region 2.” If a call to Deployment 1 is made by the service gateway 836 implemented in the control plane VCN 816 located in Region 1, the call may be transmitted to Deployment 1 in Region 1. In this example, the control plane VCN 816, or Deployment 1 in Region 1, may not be communicatively coupled to, or otherwise in communication with, Deployment 1 in Region 2.

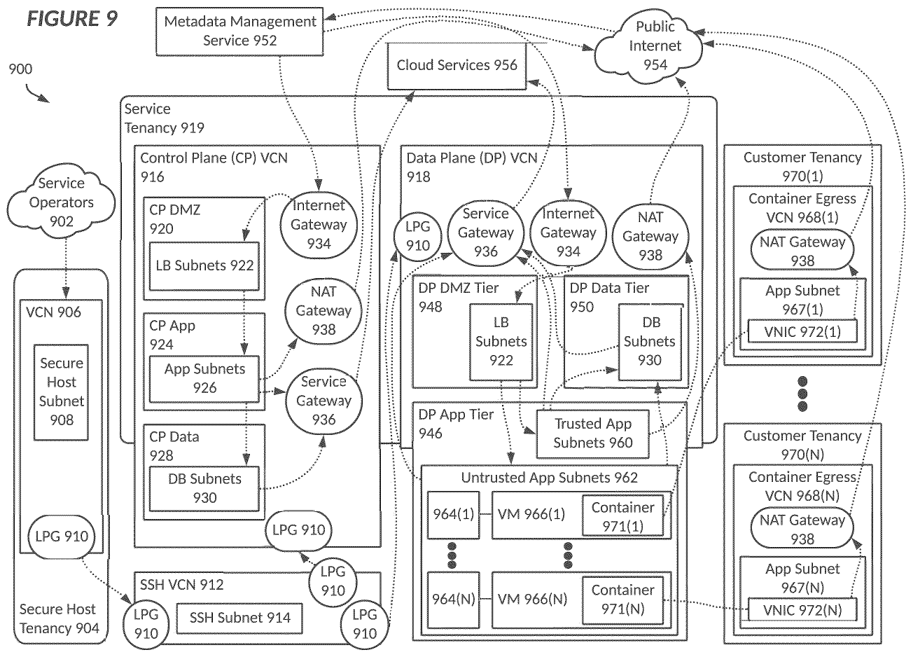

FIG. 9 is a block diagram 900 illustrating another example pattern of an IaaS architecture, according to at least one embodiment. Service operators 902 (e.g., service operators 702 of FIG. 7) can be communicatively coupled to a secure host tenancy 904 (e.g., the secure host tenancy 704 of FIG. 7) that can include a virtual cloud network (VCN) 906 (e.g., the VCN 706 of FIG. 7) and a secure host subnet 908 (e.g., the secure host subnet 708 of FIG. 7). The VCN 906 can include an LPG 910 (e.g., the LPG 710 of FIG. 7) that can be communicatively coupled to an SSH VCN 912 (e.g., the SSH VCN 712 of FIG. 7) via an LPG 910 implemented in the SSH VCN 912. The SSH VCN 912 can include an SSH subnet 914 (e.g., the SSH subnet 714 of FIG. 7), and the SSH VCN 912 can be communicatively coupled to a control plane VCN 916 (e.g., the control plane VCN 716 of FIG. 7) via an LPG 910 implemented in the control plane VCN 916 and to a data plane VCN 918 (e.g., the data plane VCN 718 of FIG. 7) via an LPG 910 implemented in the data plane VCN 918. The control plane VCN 916 and the data plane VCN 918 can be implemented in a service tenancy 919 (e.g., the service tenancy 719 of FIG. 7).

The control plane VCN 916 can include a control plane DMZ tier 920 (e.g., the control plane DMZ tier 720 of FIG. 7) that can include load balancer (LB) subnet(s) 922 (e.g., LB subnet(s) 722 of FIG. 7), a control plane app tier 924 (e.g., the control plane app tier 724 of FIG. 7) that can include app subnet(s) 926 (e.g., similar to app subnet(s) 726 of FIG. 7), and a control plane data tier 928 (e.g., the control plane data tier 728 of FIG. 7) that can include DB subnet(s) 930. The LB subnet(s) 922 implemented in the control plane DMZ tier 920 can be communicatively coupled to the app subnet(s) 926 implemented in the control plane app tier 924 and to an Internet gateway 934 (e.g., the Internet gateway 734 of FIG. 7) that can be implemented in the control plane VCN 916, and the app subnet(s) 926 can be communicatively coupled to the DB subnet(s) 930 implemented in the control plane data tier 928 and to a service gateway 936 (e.g., the service gateway of FIG. 7) and a network address translation (NAT) gateway 938 (e.g., the NAT gateway 738 of FIG. 7). The control plane VCN 916 can include the service gateway 936 and the NAT gateway 938.

The data plane VCN 918 can include a data plane app tier 946 (e.g., the data plane app tier 746 of FIG. 7), a data plane DMZ tier 948 (e.g., the data plane DMZ tier 748 of FIG. 7), and a data plane data tier 950 (e.g., the data plane data tier 750 of FIG. 7). The data plane DMZ tier 948 can include LB subnet(s) 922 that can be communicatively coupled to trusted app subnet(s) 960, untrusted app subnet(s) 962 of the data plane app tier 946, and the Internet gateway 934 implemented in the data plane VCN 918. The trusted app subnet(s) 960 can be communicatively coupled to the service gateway 936 implemented in the data plane VCN 918, the NAT gateway 938 implemented in the data plane VCN 918, and DB subnet(s) 930 implemented in the data plane data tier 950. The untrusted app subnet(s) 962 can be communicatively coupled to the service gateway 936 implemented in the data plane VCN 918 and DB subnet(s) 930 implemented in the data plane data tier 950. The data plane data tier 950 can include DB subnet(s) 930 that can be communicatively coupled to the service gateway 936 implemented in the data plane VCN 918.

The untrusted app subnet(s) 962 can include one or more primary VNICs 964(1)-(N) that can be communicatively coupled to tenant virtual machines (VMs) 966(1)-(N). Tenant VMs 966(1)-(N) can be communicatively coupled to a respective app subnets 967(1)-(N) that can be implemented in respective container egress VCNs 968(1)-(N) that can be implemented in respective customer tenancies 970(1)-(N). Respective secondary VNICs 972(1)-(N) can facilitate communication between the untrusted app subnet(s) 962 implemented in the data plane VCN 918 and the app subnet implemented in the container egress VCNs 968(1)-(N). Container egress VCNs 968(1)-(N) can include a NAT gateway 938 that can be communicatively coupled to public Internet 954 (e.g., public Internet 754 of FIG. 7).

The Internet gateway 934 implemented in the control plane VCN 916 and implemented in the data plane VCN 918 can be communicatively coupled to a metadata management service 952 (e.g., the metadata management service 752 of FIG. 7) that can be communicatively coupled to public Internet 954. Public Internet 954 can be communicatively coupled to the NAT gateway 938 implemented in the control plane VCN 916 and implemented in the data plane VCN 918. The service gateway 936 implemented in the control plane VCN 916 and implemented in the data plane VCN 918 can be communicatively couple to cloud services 956.

In some embodiments, the data plane VCN 918 can be integrated with customer tenancies 970(1)-(N). This integration can be useful or needed for customers of the IaaS provider in some cases such as a case that may need support when executing code. The customer may provide code to execute that may be destructive, may communicate with other customer resources, or may otherwise cause undesirable effects. In response to this, the IaaS provider may determine whether or not to execute code given to the IaaS provider by the customer.

In some examples, the customer of the IaaS provider may grant temporary network access to the IaaS provider and request a function to be attached to the data plane app tier 946. Code to execute the function may be executed in the VMs 966(1)-(N), and the code may not be configured to execute anywhere else on the data plane VCN 918. VMs 966(1)-(N) may be connected to one customer tenancy 970(1). Respective containers 971(1)-(N) implemented in the VMs 966(1)-(N) may be configured to execute the code. In this case, there can be a dual isolation (e.g., the containers 971(1)-(N) executing code), where the containers 971(1)-(N) may be implemented in at least the VM 966(1)-(N) that are implemented in the untrusted app subnet(s) 962) that may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completing execution of the code, the IaaS provider may terminate or otherwise dispose of the containers 971(1)-(N).

In some embodiments, the trusted app subnet(s) 960 may execute code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be implemented in the VM 966(1)-(N) of a customer and that may execute code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

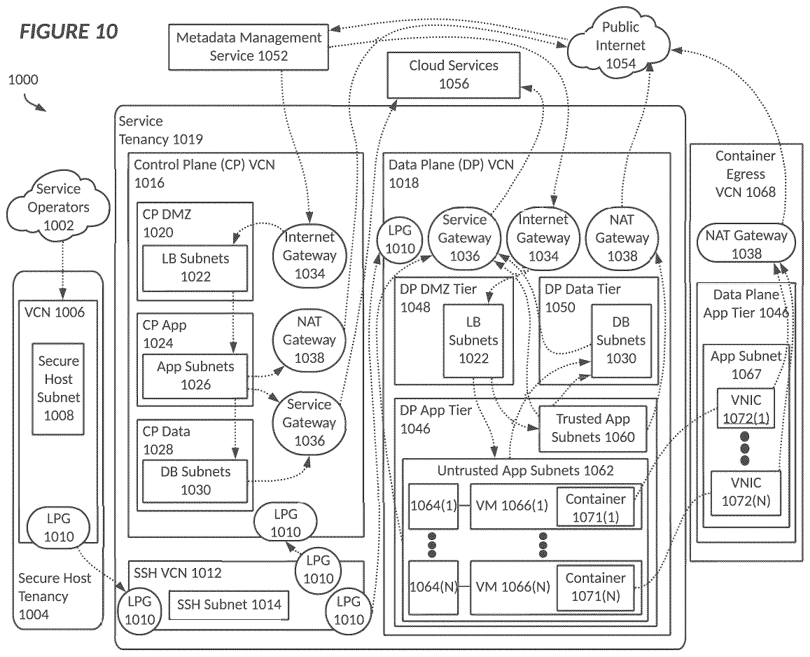

FIG. 10 is a block diagram illustrating another example pattern of an IaaS architecture 1000 according to at least one embodiment. Service operators 1002 (e.g., service operators 702 of FIG. 7) can be communicatively coupled to a secure host tenancy 1004 (e.g., the secure host tenancy 704 of FIG. 7) that can include a virtual cloud network (VCN) 1006 (e.g., the VCN 706 of FIG. 7) and a secure host subnet 1008 (e.g., the secure host subnet 708 of FIG. 7). The VCN 1006 can include an LPG 1010 (e.g., the LPG 710 of FIG. 7) that can be communicatively coupled to an SSH VCN 1012 (e.g., the SSH VCN 712 of FIG. 7) via an LPG 1010 implemented in the SSH VCN 1012. The SSH VCN 1012 can include an SSH subnet 1014 (e.g., the SSH subnet 714 of FIG. 7), and the SSH VCN 1012 can be communicatively coupled to a control plane VCN 1016 (e.g., the control plane VCN 716 of FIG. 7) via an LPG 1010 implemented in the control plane VCN 1016 and to a data plane VCN 1018 (e.g., the data plane VCN 718 of FIG. 7) via an LPG 1010 implemented in the data plane VCN 1018. The control plane VCN 1016 and the data plane VCN 1018 can be implemented in a service tenancy 1019 (e.g., the service tenancy 719 of FIG. 7).

The control plane VCN 1016 can include a control plane DMZ tier 1020 (e.g., the control plane DMZ tier 720 of FIG. 7) that can include LB subnet(s) 1022 (e.g., LB subnet(s) 722 of FIG. 7), a control plane app tier 1024 (e.g., the control plane app tier 724 of FIG. 7) that can include app subnet(s) 1026 (e.g., app subnet(s) 726 of FIG. 7), and a control plane data tier 1028 (e.g., the control plane data tier 728 of FIG. 7) that can include DB subnet(s) 1030 (e.g., DB subnet(s) 930 of FIG. 9). The LB subnet(s) 1022 implemented in the control plane DMZ tier 1020 can be communicatively coupled to the app subnet(s) 1026 implemented in the control plane app tier 1024 and to an Internet gateway 1034 (e.g., the Internet gateway 734 of FIG. 7) that can be implemented in the control plane VCN 1016, and the app subnet(s) 1026 can be communicatively coupled to the DB subnet(s) 1030 implemented in the control plane data tier 1028 and to a service gateway 1036 (e.g., the service gateway of FIG. 7) and a network address translation (NAT) gateway 1038 (e.g., the NAT gateway 738 of FIG. 7). The control plane VCN 1016 can include the service gateway 1036 and the NAT gateway 1038.

The data plane VCN 1018 can include a data plane app tier 1046 (e.g., the data plane app tier 746 of FIG. 7), a data plane DMZ tier 1048 (e.g., the data plane DMZ tier 748 of FIG. 7), and a data plane data tier 1050 (e.g., the data plane data tier 750 of FIG. 7). The data plane DMZ tier 1048 can include LB subnet(s) 1022 that can be communicatively coupled to trusted app subnet(s) 1060 (e.g., trusted app subnet(s) 960 of FIG. 9) and untrusted app subnet(s) 1062 (e.g., untrusted app subnet(s) 962 of FIG. 9) of the data plane app tier 1046 and the Internet gateway 1034 implemented in the data plane VCN 1018. The trusted app subnet(s) 1060 can be communicatively coupled to the service gateway 1036 implemented in the data plane VCN 1018, the NAT gateway 1038 implemented in the data plane VCN 1018, and DB subnet(s) 1030 implemented in the data plane data tier 1050. The untrusted app subnet(s) 1062 can be communicatively coupled to the service gateway 1036 implemented in the data plane VCN 1018 and DB subnet(s) 1030 implemented in the data plane data tier 1050. The data plane data tier 1050 can include DB subnet(s) 1030 that can be communicatively coupled to the service gateway 1036 implemented in the data plane VCN 1018.

The untrusted app subnet(s) 1062 can include primary VNICs 1064(1)-(N) that can be communicatively coupled to tenant virtual machines (VMs) 1066(1)-(N) implemented within the untrusted app subnet(s) 1062. Tenant VMs 1066(1)-(N) can execute code in a respective container 1067(1)-(N) and be communicatively coupled to an app subnet 1067 that can be implemented in a data plane app tier 1046 that can be implemented in a container egress VCN 1068. Respective secondary VNICs 1072(1)-(N) can facilitate communication between the untrusted app subnet(s) 1062 implemented in the data plane VCN 1018 and the app subnet 1067 implemented in the container egress VCN 1068. The container egress VCN 1068 can include a NAT gateway 1038 that can be communicatively coupled to public Internet 1054 (e.g., public Internet 754 of FIG. 7).

The Internet gateway 1034 implemented in the control plane VCN 1016 and implemented in the data plane VCN 1018 can be communicatively coupled to a metadata management service 1052 (e.g., the metadata management service 752 of FIG. 7) that can be communicatively coupled to public Internet 1054. Public Internet 1054 can be communicatively coupled to the NAT gateway 1038 implemented in the control plane VCN 1016 and implemented in the data plane VCN 1018. The service gateway 1036 implemented in the control plane VCN 1016 and implemented in the data plane VCN 1018 can be communicatively couple to cloud services 1056.

In some examples, the pattern illustrated by the architecture of block diagram 1000 of FIG. 10 may be considered an exception to the pattern illustrated by the architecture of block diagram 900 of FIG. 9 and may be needed for a customer of the IaaS provider if the IaaS provider cannot directly communicate with the customer (e.g., a disconnected region). The respective containers 1071(1)-(N) that are implemented in the VMs 1066(1)-(N) for a customer can be accessed in real-time by the customer. The containers 1071(1)-(N) may be configured to make calls to respective secondary VNICs 1072(1)-(N) implemented in app subnet(s) 1067 of the data plane app tier 1046 that can be implemented in the container egress VCN 1068. The secondary VNICs 1072(1)-(N) can transmit the calls to the NAT gateway 1038 that may transmit the calls to public Internet 1054. In this example, the containers 1071(1)-(N) that can be accessed in real time by the customer can be isolated from the control plane VCN 1016 and can be isolated from other entities implemented in the data plane VCN 1018. The containers 1071(1)-(N) may also be isolated from resources from other customers.

In other examples, the customer can use the containers 1071(1)-(N) to call cloud services 1056. In this example, the customer may execute code in the containers 1071(1)-(N) that request a service from cloud services 1056. The containers 1071(1)-(N) can transmit this request to the secondary VNICs 1072(1)-(N) that can transmit the request to the NAT gateway 1038 that can transmit the request to public Internet 1054. Public Internet 1054 can transmit the request to LB subnet(s) 1022 implemented in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, and 1000 may include components that are different and/or additional to the components shown in the figures. Furthermore, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. A node may be local to and/or remote from another node. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. A node in an overlay network corresponds to a respective node in the underlying network. Hence, a node in an overlay network may be associated with both an overlay address (for data to be addressed to the overlay node) and an underlay address (for data to be addressed to the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of other clients. Network resources are dynamically assigned to the requests and/or clients on an on-demand basis. Network resources assigned to a request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited to, Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources may be provisioned for an entity that is independent from other entities (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud may have dependencies on applications implemented at the public cloud and vice-versa. A call from an application at the private cloud to an application at the public cloud (and vice versa) may be executed through the interface.

In an embodiment, a tenant of a multi-tenant computer network is independent of another tenant of the same multi-tenant computer network. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared across tenants. Various tenant isolation approaches may be used.

In an embodiment, a tenant is associated with a tenant ID. A network resource of the multi-tenant computer network is tagged with a tenant ID. A tenant is permitted access to a particular network resource when the tenant and the particular network resources are associated with a same tenant ID.

In an embodiment, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, a database implemented by a multi-tenant computer network may be tagged with a tenant ID. A tenant associated with the corresponding tenant ID may access data of a particular database. As another example, an entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for a tenant, a set of applications that the tenant is authorized to access. For an application, a list of tenant IDs of tenants authorized to access the application is stored. A tenant is permitted access to a particular application when the tenant ID of the tenant is implemented in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. Computer System

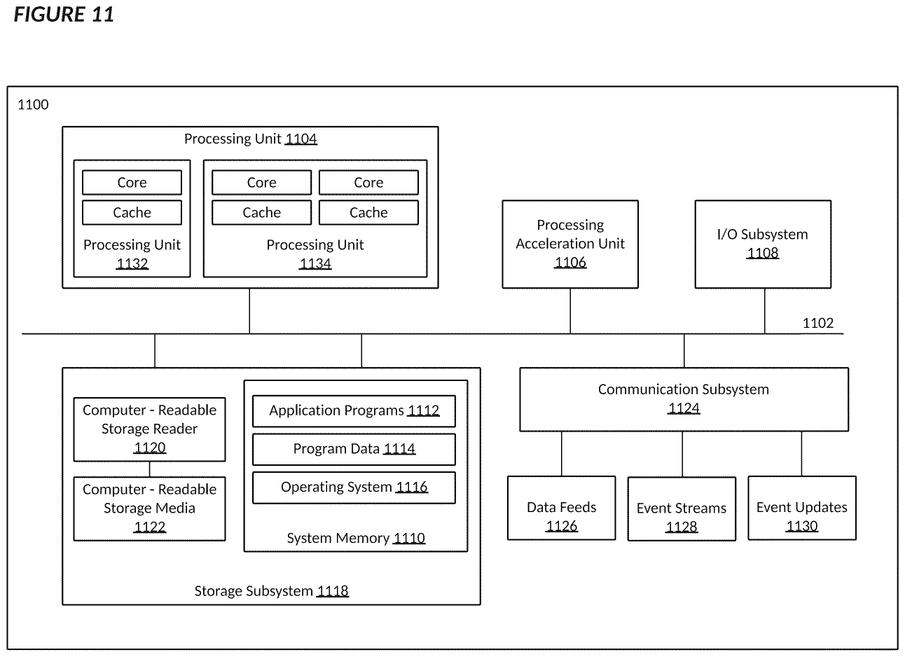

FIG. 11 illustrates an example computer system 1100. An embodiment of the disclosure may be implemented upon the computer system 1100. As shown in FIG. 11, computer system 1100 includes a processing unit 1104 that communicates with peripheral subsystems via a bus subsystem 1102. These peripheral subsystems may include a processing acceleration unit 1106, an I/O subsystem 1108, a storage subsystem 1118, and a communications subsystem 1124. Storage subsystem 1118 includes tangible computer-readable storage media 1122, computer-readable storage reader 1120 and a system memory 1110.

Bus subsystem 1102 provides a mechanism for letting the various components and subsystems of computer system 1100 to communicate with other components and subsystems as intended. Although bus subsystem 1102 is shown schematically as a single bus, alternative embodiments of the bus subsystem may utilize multiple buses. Bus subsystem 1102 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the Institute of Electrical and Electronics Engineers (IEEE) P1386.1 standard.

Processing unit 1104 controls the operation of computer system 1100. Processing unit 1104 can be implemented as one or more integrated circuits (e.g., a conventional microprocessor or microcontroller). One or more processors may be implemented in processing unit 1104. These processors may include single core or multicore processors. In certain embodiments, processing unit 1104 may be implemented as one or more independent sub processing units 1132 and/or 1134 with single or multicore processors implemented in one or more processing units. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, the program code to be executed can be wholly or partially implemented in processing unit 1104 and/or in storage subsystem 1118. Through suitable programming, processing unit 1104 can provide various functionalities described above. Computer system 1100 may additionally include a processing acceleration unit 1106 that can include a digital signal processor (DSP), a special-purpose processor, and/or the like.

I/O subsystem 1108 may include user interface input devices and user interface output devices. User interface input devices may include a keyboard, pointing devices, such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices, such as the Microsoft Kinect® motion sensor that enables users to control and interact with an input device, such as the Microsoft Xbox® 360 game controller, through a natural user interface using gestures and spoken commands. User interface input devices may also include eye gesture recognition devices, such as the Google Glass® blink detector, that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices, such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices, such as computed tomography, magnetic resonance imaging, position emission tomography, or medical ultrasonography devices. User interface input devices may also include audio input devices, such as MIDI keyboards, digital musical instruments and the like.

User interface output devices may include a display subsystem, indicator lights, or non-visual displays, such as audio output devices. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 1100 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 1100 may comprise a storage subsystem 1118 that provides a tangible, non-transitory, computer-readable storage medium for storing software and data constructs that provide the functionality of the embodiments described in this disclosure. The software can include programs, code modules, instructions, scripts, etc., that, when executed by one or more cores or processors of processing unit 1104, provide the functionality described above. Storage subsystem 1118 may also provide a repository for storing data used in accordance with the present disclosure.

As depicted in the example in FIG. 11, storage subsystem 1118 can include various components, including a system memory 1110, computer-readable storage media 1122, and a computer-readable storage media reader 1120. System memory 1110 may store program instructions, such as application programs 1112, that are loadable and executable by processing unit 1104. System memory 1110 may also store data, such as program data 1114, that is used during the execution of the instructions and/or data that is generated during the execution of the program instructions. Various programs may be loaded into system memory 1110 including, but not limited to, client applications, Web browsers, mid-tier applications, relational database management systems (RDBMS), virtual machines, containers, etc.

System memory 1110 may also store an operating system 1116. Examples of operating system 1116 may include various versions of Microsoft Windows®, Apple Macintosh®, and/or Linux operating systems, a variety of commercially available UNIX® or UNIX-like operating systems (including without limitation the variety of GNU/Linux operating systems, the Google Chrome® OS, and the like) and/or mobile operating systems, such as iOS, Windows® Phone, Android® OS, BlackBerry® OS, and Palm® OS operating systems. In certain implementations where computer system 1100 executes one or more virtual machines, the virtual machines along with their guest operating systems (GOSs) may be loaded into system memory 1110 and executed by one or more processors or cores of processing unit 1104.

System memory 1110 can come in different configurations depending upon the type of computer system 1100. For example, system memory 1110 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 1110 may include a basic input/output system (BIOS) including basic routines that help to transfer information between elements within computer system 1100 such as during start-up.

Computer-readable storage media 1122 may represent remote, local, fixed, and/or removable storage devices plus storage media for temporarily and/or more permanently including and storing computer-readable information for use by computer system 1100, including instructions executable by processing unit 1104 of computer system 1100.

Computer-readable storage media 1122 can include any appropriate media known or used in the field, including storage media and communication media, such as but not limited to volatile and non-volatile, removable and non-removable media implemented in any method or technology for storage and/or transmission of information. This can include tangible, computer-readable storage media, such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible, computer-readable media.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk, such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include solid-state drives (SSD) based on non-volatile memory, such as flash-memory based SSDs, enterprise flash drives, solid state ROM, and the like, SSDs based on volatile memory, such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated, computer-readable media may provide non-volatile storage of computer-readable instructions, data structures, program modules, and other data for computer system 1100.

Machine-readable instructions executable by one or more processors or cores of processing unit 1104 may be stored on a non-transitory, computer-readable storage medium. A non-transitory, computer-readable storage medium can include physically tangible memory or storage devices that include volatile memory storage devices and/or non-volatile storage devices. Examples of non-transitory, computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments, communications subsystem 1124 can include radio frequency (RF) transceiver components to access wireless voice and/or data networks (e.g., using cellular telephone technology, advanced data network technology, such as 3G, 4G, or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real time from users of social networks and/or other communication services, such as Twitter® feeds, Facebook® updates, web feeds, such as Rich Site Summary (RSS) feeds, and/or real-time updates from one or more third party information sources.

Additionally, communications subsystem 1124 may be configured to receive data in the form of continuous data streams. The continuous data streams may include event streams 1128 of real-time events and/or event updates 1130 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in FIG. 11 is intended as a non-limiting example. Many other configurations having more or fewer components than the system depicted in FIG. 11 are possible. For example, customized hardware might also be used and/or particular elements might be implemented in hardware, firmware, software (including applets), or a combination. Furthermore, connection to other computing devices, such as network input/output devices, may be employed. Based on the disclosure and teachings provided herein, a person of ordinary skill in the art will appreciate other ways and/or methods to implement the various embodiments.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, a computer program product includes instructions that, when executed by one or more hardware processors, causes performance of any of the operations described herein and/or recited in any of the claims.

In an embodiment, one or more non-transitory computer-readable storage media store instructions that, when executed by one or more hardware processors, cause performance of any of the operations described herein and/or recited in any of the claims. As used herein, the term “non-transitory computer-readable medium” refers to any tangible storage medium that stores computer-executable instructions for execution by one or more hardware processors in a computing device(s). The term “non-transitory” excludes transitory, propagating signals per se, such as carrier waves or other electromagnetic signals, but includes all forms of physical storage media.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form in which such claims issue, including any subsequent correction.

What is claimed is:

1. A method comprising:
receiving, by a first cross-realm service, a first user input comprising a first request to activate a first pipeline for a communication channel between the first pipeline and a second pipeline, wherein:
the first user input comprises at least a portion of a pipeline identifier of the second pipeline;
the first pipeline and the first cross-realm service are deployed in a first realm, and the second pipeline is deployed in a second realm; and
cross-realm communications from the first realm to the second realm are associated with a first restriction level, cross-realm communications from the second realm to the first realm are associated with a second restriction level, and the first restriction level differs from the second restriction level;
activating, by the first cross-realm service, the first pipeline for the communication channel between the first pipeline and the second pipeline, wherein activating the first pipeline comprises:
based on at least the portion of the pipeline identifier of the second pipeline, adding to a set of pipeline mappings stored in the first realm, a mapping between the first pipeline and the second pipeline;
wherein data is transmitted over the communication channel based on the mapping between the first pipeline and the second pipeline stored in the first realm without relying on any mapping between the first pipeline and the second pipeline stored in the second realm;
wherein the method is performed by at least one device including a hardware processor.

2. The method of claim 1, wherein data is transmitted over the communication channel between the first pipeline and the second pipeline based on the mapping between the first pipeline and the second pipeline stored in the first realm without identifying the first pipeline outside the first realm.

3. The method of claim 1, further comprising:
receiving, by a second cross-realm service deployed in the second realm, a second user input comprising a second request to activate the second pipeline for the communication channel between the first pipeline and the second pipeline, wherein
the second user input does not identify any portion of a first pipeline identifier of the first pipeline;
activating, by the second cross-realm service, the second pipeline for the communication channel between the first pipeline and the second pipeline.

4. The method of claim 3, further comprising:
wherein activating the second pipeline does not comprise storing any mapping between the first pipeline and the second pipeline in the second realm.

5. The method of claim 4, wherein activating the second pipeline does not comprise identifying the first pipeline outside the first realm.

6. The method of claim 1,
wherein the first restriction level for cross-realm communications from the first realm to the second realm is higher than the second restriction level for cross-realm communications from the second realm to the first realm;
wherein the method further comprises:
receiving, by the first cross-realm service, a set of data comprising a file and a sender pipeline identifier of a sender pipeline, wherein the sender pipeline is the second pipeline;
accessing, by the first cross-realm service, the set of pipeline mappings;
based on the sender pipeline identifier, identifying, in the set of pipeline mappings, the mapping between the first pipeline and the second pipeline;
based on the mapping between the first pipeline and the second pipeline, identifying, by the first cross-realm service, the first pipeline as a receiver pipeline;
in response to identifying the first pipeline as the receiver pipeline: transmitting, by the first cross-realm service, the file to a receiver data storage unit designated for receiving files transmitted to the receiver pipeline over the communication channel.

7. The method of claim 6, further comprising:
obtaining the file, by a second cross-realm service deployed in the second realm, from a sender data storage unit corresponding to the sender pipeline;
generating, by the second cross-realm service, a manifest comprising the sender pipeline identifier of the sender pipeline, wherein the sender pipeline identifier identifies the second pipeline as the sender pipeline;
initiating, by the second cross-realm service, transmission of the set of data towards the first realm, the set of data comprising the file and the manifest.

8. The method of claim 6, further comprising:
prior to the first cross-realm service receiving the first user input comprising the first request to activate the first pipeline:
generating, by a second cross-realm service deployed in the second realm, a key pair for the sender pipeline, the key pair comprising a public key and a private key;
initiating, by the second cross-realm service, transmission of a control message comprising the pipeline identifier of the second pipeline and the public key of the key pair;
wherein the first cross-realm service receives the control message and stores, in a data repository, the public key in association with the pipeline identifier.

9. The method of claim 8, further comprising:
encrypting, by the second cross-realm service, messages to be transmitted via the communication channel using the private key of the key pair; and
decrypting, by the first cross-realm service, messages received via the communication channel using the public key of the key pair.

10. The method of claim 6,
wherein the mapping between the first pipeline and the second pipeline comprises a sender pipeline field mapped to a receiver pipeline field, the receiver pipeline field comprising a first string of characters identifying the first pipeline as the receiver pipeline, the sender pipeline field comprising a second string of characters identifying the second pipeline as the sender pipeline;
wherein identifying the mapping between the first pipeline and the second pipeline based on the sender pipeline identifier comprises:
determining that the second string of characters, identifying the second pipeline as the sender pipeline, comprises the sender pipeline identifier from the set of data received by the first cross-realm service;
wherein identifying the first pipeline as the receiver pipeline based on the mapping between the first pipeline and the second pipeline comprises:
identifying the receiver pipeline field mapped to the sender pipeline field;
determining that the first string of characters of the receiver pipeline field identifies the first pipeline.

11. The method of claim 1,
wherein the first restriction level for cross-realm communications from the first realm to the second realm is higher than the second restriction level for cross-realm communications from the second realm to the first realm;
wherein the method further comprises:
obtaining a file, by the first cross-realm service from a sender data storage unit corresponding to a sender pipeline, wherein the sender pipeline is the first pipeline;
accessing, by the first cross-realm service, the set of pipeline mappings;
based on a sender pipeline identifier of the sender pipeline, identifying, in the set of pipeline mappings, the mapping between the first pipeline and the second pipeline;
based on the mapping between the first pipeline and the second pipeline, identifying, by the first cross-realm service, the second pipeline as a receiver pipeline;
in response to identifying the second pipeline as the receiver pipeline:
generating, by the first cross-realm service, a manifest comprising a receiver pipeline identifier of the receiver pipeline, wherein the receiver pipeline identifier identifies the second pipeline as the receiver pipeline;
initiating, by the first cross-realm service, transmission of a set of data to the second realm, the set of data comprising the file and the manifest.

12. The method of claim 11, further comprising:
receiving, by a second cross-realm service deployed in the second realm, the set of data comprising the file and the manifest;
accessing, by the second cross-realm service, the manifest;
based on the manifest, determining the receiver pipeline identifier of the receiver pipeline;
based on the receiver pipeline identifier, identifying, by the second cross-realm service, the second pipeline as the receiver pipeline;
in response to identifying the second pipeline as the receiver pipeline: transmitting, by the second cross-realm service, the file to a receiver data storage unit designated for receiving files transmitted to the receiver pipeline over the communication channel.

13. The method of claim 11, further comprising:
prior to the first cross-realm service initiating transmission of the set of data to the second realm:
generating, by the first cross-realm service, a key pair for encrypting and decrypting messages from the first realm, the key pair comprising a public key and a private key;
initiating, by the first cross-realm service, transmission of the public key to the second realm;
wherein the public key is stored in the second realm for use by a second cross-realm service deployed in the second realm for decrypting messages from the first realm that are encrypted with the private key.

14. The method of claim 1, wherein the pipeline identifier of the second pipeline comprises a first portion of a string of characters, the string of characters identifying the second pipeline, wherein the pipeline identifier does not include a second portion of the string of characters identifying the second pipeline.

15. The method of claim 1, wherein the second realm does not have access to any identifying information of the first pipeline.

16. The method of claim 1, wherein the second realm does have access to any mapping between any pipeline in the first realm and any pipeline in the second realm.

17. The method of claim 1, wherein no information from the first realm is transmitted to the second realm over the communication channel.

18. A method, comprising:
establishing (a) a first cross-realm communication channel for transmitting data from a first sender realm to a first receiver realm and (b) a second cross-realm communication channel for transmitting data from a second sender realm to a second receiver realm,
wherein the first cross-realm communication channel is established utilizing a first process that accommodates a first restriction on data egress from the first receiver realm,
wherein the second cross-realm communication channel is established utilizing a second process that accommodates a second restriction on data egress from the second sender realm;
wherein establishing the first cross-realm communication channel comprises:
receiving, by a first cross-realm receiver service deployed in the first receiver realm, a first user input comprising a first request to activate a first receiver pipeline deployed in the first receiver realm for the first cross-realm communication channel, the first user input comprising at least a portion of a first pipeline identifier of a first sender pipeline deployed in the first sender realm,
activating, by the first cross-realm receiver service, the first receiver pipeline for the first cross-realm communication channel, wherein activating the first receiver pipeline comprises:
based on at least the portion of the first pipeline identifier of the first sender pipeline, adding to a first set of pipeline mappings stored in the first receiver realm, a first mapping between the first receiver pipeline and the first sender pipeline;
receiving, by a first cross-realm sender service deployed in the first sender realm, a second user input comprising a second request to activate the first sender pipeline for the first cross-realm communication channel, wherein the second user input does not identify the first receiver pipeline;
activating, by the first cross-realm sender service, the first sender pipeline for the first cross-realm communication channel, wherein activating the first sender pipeline does not comprise identifying the first receiver pipeline in the first sender realm;
wherein data is transmitted over the first cross-realm communication channel from the first sender pipeline to the first receiver pipeline based on the first mapping in the first set of pipeline mappings stored in the first receiver realm without identifying the first receiver pipeline outside the first receiver realm;
wherein establishing the second cross-realm communication channel comprises:
receiving, by a second cross-realm sender service deployed in the second sender realm, a third user input comprising a third request to activate a second sender pipeline deployed in the second sender realm for the second cross-realm communication channel, the third user input comprising at least a portion of a second pipeline identifier of a second receiver pipeline deployed in the second receiver realm,
activating, by the second cross-realm sender service, the second sender pipeline for the second cross-realm communication channel, wherein activating the second sender pipeline comprises:
based on at least the portion of the second pipeline identifier of the second receiver pipeline, adding to a second set of pipeline mappings stored in the second sender realm, a second mapping between the second sender pipeline and the second receiver pipeline;
receiving, by a second cross-realm receiver service deployed in the second receiver realm, a fourth user input comprising a fourth request to activate the second receiver pipeline for the second cross-realm communication channel, wherein the fourth user input does not identify the second sender pipeline;
activating, by the second cross-realm receiver service, the second receiver pipeline for the second cross-realm communication channel, wherein activating the second receiver pipeline does not comprise identifying the second sender pipeline in the second receiver realm;
wherein data is transmitted over the second cross-realm communication channel from the second sender pipeline to the second receiver pipeline based on the second mapping in the second set of pipeline mappings stored in the second sender realm without identifying the second sender pipeline outside the second sender realm.

19. One or more non-transitory computer-readable media storing instructions that, when executed by one or more hardware processors, cause performance of operations comprising:
receiving, by a first cross-realm service, a first user input comprising a first request to activate a first pipeline for a communication channel between the first pipeline and a second pipeline, wherein:
the first user input comprises at least a portion of a pipeline identifier of the second pipeline;
the first pipeline and the first cross-realm service are deployed in a first realm, and the second pipeline is deployed in a second realm; and
cross-realm communications from the first realm to the second realm are associated with a first restriction level, cross-realm communications from the second realm to the first realm are associated with a second restriction level, and the first restriction level differs from the second restriction level;
activating, by the first cross-realm service, the first pipeline for the communication channel between the first pipeline and the second pipeline, wherein activating the first pipeline comprises:
based on at least the portion of the pipeline identifier of the second pipeline, adding to a set of pipeline mappings stored in the first realm, a mapping between the first pipeline and the second pipeline;
wherein data is transmitted over the communication channel based on the mapping between the first pipeline and the second pipeline stored in the first realm without relying on any mapping between the first pipeline and the second pipeline stored in the second realm.

20. A system comprising:
one or more hardware processors;
one or more non-transitory computer-readable media; and
program instructions stored on the one or more non-transitory computer-readable media that, when executed by the one or more hardware processors, cause the system to perform operations comprising:
receiving, by a first cross-realm service, a first user input comprising a first request to activate a first pipeline for a communication channel between the first pipeline and a second pipeline, wherein:
the first user input comprises at least a portion of a pipeline identifier of the second pipeline;
the first pipeline and the first cross-realm service are deployed in a first realm, and the second pipeline is deployed in a second realm; and
cross-realm communications from the first realm to the second realm are associated with a first restriction level, cross-realm communications from the second realm to the first realm are associated with a second restriction level, and the first restriction level differs from the second restriction level;
activating, by the first cross-realm service, the first pipeline for the communication channel between the first pipeline and the second pipeline, wherein activating the first pipeline comprises:
based on at least the portion of the pipeline identifier of the second pipeline, adding to a set of pipeline mappings stored in the first realm, a mapping between the first pipeline and the second pipeline;
wherein data is transmitted over the communication channel based on the mapping between the first pipeline and the second pipeline stored in the first realm without relying on any mapping between the first pipeline and the second pipeline stored in the second realm.
